(19) United States
(12) Patent Application Publication
(10) Pub. No.: US 2007/0224471 A1
(43) Pub. Date: Sep. 27, 2007

(54) Fuel Cell Power Generation System

(76) Inventors: Yoshikazu Tanaka, Osaka (JP); Akinari Nakamura, Osaka (JP); Masataka Ozeki, Osaka (JP); Hideo Ohara, Osaka (JP)

Correspondence Address: MCDERMOTT WILL & EMERY LLP, 600 13TH STREET, N.W., WASHINGTON, DC, 20005-3096, US

(21) Appl. No.: 11/628,079

(22) PCT Filed: Aug. 4, 2005
(86) PCT No.: PCT/JP05/14352

§ 371 Date: Nov. 30, 2006

(30) Foreign Application Priority Data
Aug. 6, 2004 (JP) 2004-230822

(51) Int. Cl. H01M 8/04; H01M 8/06

(52) U.S. Cl. 429/22

(57) ABSTRACT

A fuel cell power generation system of the present invention comprises a fuel cell (11), an object subjected to degradation determination (14, 15, 16) which is at least one of one or more fluid supply devices (14, 15, 16) that supply fluids associated with power generation in the fuel cell, a flow rate detecting means (18, 19, 20at directly or indirectly detects a flow rate of the fluid supplied from the object subjected to degradation determination, a flow rate control means (24) that controls the flow rate of the fluid supplied from the object subjected to degradation determination, a degradation determination means (25) that determines whether or not degradation has occurred in the object subjected to degradation determination (14, 15, 16) and an operation control means (26) that controls an operation of the fuel cell power generation system, and the degradation determination means (25) determines whether or not the degradation has occurred in the object subjected to degradation determination (14, 15, 16), based on the output command value given by the flow rate control means (24) to the object subjected to degradation determination (14, 15, 16) and the detection value of the flow rate that is detected by the flow rate detecting means (18, 19, 20).

### TECHNICAL FIELD

The present invention relates to a fuel cell power generation system. More particularly, the present invention relates to a fuel cell power generation system configured to determine whether or not degradation has occurred in fluid supply devices and to continue power generation in an allowable range or to stop an operation depending on the degree of the degradation.

### BACKGROUND ART

To operate a fuel cell power generation system, it is necessary to supply fluids such as air or water to a reformer, a fuel cell, etc, in a required amount and without excess and deficiency. In a conventional fuel cell power generation system, the fluids are supplied by fluid supply devices such as a blower or a pump, and flow rates of the fluids are measured by flow meters (see e.g., patent document 1). FIG. 20 is a block diagram schematically showing a construction of the conventional fuel cell power generation system disclosed in the patent document 1. As shown in FIG. 20, the conventional fuel cell power generation system includes a fuel cell, a fuel processor, a blower that supplies a material gas to the fuel processor, a pump that supplies water to the fuel processor, and a flow meter that detects a flow rate of water.

When abnormality has occurred in, for example, a fuel cell stack, in the fuel cell power generation system, failure or the like is likely to occur in the devices if the operation is continued without any change. For this reason, some conventional fuel cell power generation systems are equipped with a device or the like for monitoring performance of the fuel cell stack (see e.g., patent document 2). The patent document 2 discloses a method of dealing with occurrence of abnormality by, for example, separating the fuel cell power generation system from a load when the abnormality of the fuel cell stack is detected.

Since the fuel cell generates heat through a power generation reaction, cooling water is circulated within the fuel cell by the pump, etc to remove heat. If circulation of the cooling water is impeded by abnormality of the pump, etc, then the fuel cell may be in some cases severely damaged by heat. In order to protect the fuel cell, there have been disclosed a method that detects a pressure difference of a cooling water passage, and conducts abnormality notification or forcibly stops the fuel cell if abnormality is detected (patent document 3), or a method that reduces a power output of the fuel cell to restore process values of a cooling water temperature, a cooling water flow rate, and so on, to normal ones upon detecting abnormality in these process values, thus continuing the operation (patent document 4), and a method that detects a flow rate or a pressure of a cooling medium and limits the power output of the fuel cell or stops the operation of the fuel cell if abnormality is detected (patent document 5).
Patent document 1: Japanese Laid-Open Patent Application Publication No. 2003-257463
Patent document 2: Japanese Laid-Open Patent Application Publication No. 2000-67896
Patent document 3: Japanese Laid-Open Patent Application Publication No. 2003-168454
Patent document 4: Japanese Laid-Open Patent Application Publication No. Hei. 8-195208
Patent document 5: Japanese Laid-Open Patent Application Publication No. 2002-184435

### DISCLOSURE OF THE INVENTION

### Problems to be Solved by the Invention

If the operation of the fuel cell power generation system is stopped if abnormality is detected in the cooling water system as described in the patent documents 3 to 5, then supply of the electric power stops. There has been a problem that abrupt strop of the operation severely affects home life or the like, because the fuel cell power generation system serves as a life line. In a cogeneration system using the fuel cell, an energy cost decreases and economic efficiency improves as the time period of a continued operation increases. If the operation is stopped every time the abnormality has occurred, then an energy to start-up the system becomes necessary, resulting in decreased economic efficiency.

If the operation is continued while limiting the power output of the fuel cell upon detecting the abnormality in the cooling water system as described in the patent documents 3 to 5, then economic efficiency may in some cases improve. However, when the abnormality in the cooling water system is severe or degradation thereof progresses, economic efficiency may in some cases decrease if the power output is dropped excessively depending on the condition of the system.

The present invention has been developed to solve the above mentioned problems, and an object of the present invention is to provide a fuel cell power generation system that is configured to control an operation thereof so that economic efficiency is ensured depending on the degrees of degradation or abnormality of fluid supply devices that are associated with the fuel cell power generation system, such as cooling water of a fuel cell.

### Means for Solving the Problems

In order to solve the above mentioned problems, a fuel cell power generation system of the present invention comprises a fuel cell; an object subjected to degradation determination which is at least one of one or more fluid supply devices that supply fluids associated with power generation in the fuel cell; a flow rate detecting means that detects a flow rate of the fluid supplied from the object subjected to degradation determination; a flow rate control means that controls the flow rate of the fluid supplied from the object subjected to degradation determination; and an operation control means that controls an operation of the fuel cell power generation system; wherein the operation control means reduces a power output of the fuel cell when the flow rate of the fluid that is supplied from the object subjected to degradation determination in response to a specified output command value given by the flow rate control means to the object subjected to degradation determination falls within a first degradation range, and stops the operation of the fuel cell power generation system when the flow rate falls within a second degradation range (claim 1). In such a configuration, when first degradation has occurred in the object subjected to degradation determination, the power output can be reduced and the operation can be continued while inhibiting flow rate deficiency. In addition, the operation can be stopped when the second degradation has occurred in the fluid supply device. Since the operation is stopped as required while minimizing the number of times of the stop, economic efficiency can be ensured.

In the fuel cell power generation system, the specified output command value may be an output command value actually given by the fluid control means, and the flow rate of the fluid supplied from the object subjected to degradation determination may be a detection value of the fluid that is detected by the flow rate detecting means when the output command value is given (claim 2). In such a configuration, because of the use of the flow rate actually detected and the output command value, simple determination is achieved.

In the fuel cell power generation system, the flow rate of the fluid supplied from the object subjected to degradation determination in response to the specified output command value given may be a prediction value that is predicted based on the output command value actually given by the fluid control means and the detection value of the flow rate that is detected by the flow rate detecting means when the output command value is actually given (claim 3). In such a configuration, determination can be executed without changing the output for the actual determination.

In the fuel cell power generation system, the specified output command value may be an output command value corresponding to a maximum power output (claim 4). In such a configuration, it is determined that the first degradation has occurred when the flow rate according to the maximum output cannot be achieved. When the flow rate falls within the first degradation range, the power output is reduced, and thus the flow rate deficiency can be effectively inhibited.

In the fuel cell power generation system, the flow rate detecting means may include a pressure detecting means that detects a pressure of the fluid supplied from the object subjected to degradation determination, and calculates the flow rate of the fluid based on the detected pressure (claim 5). In such a configuration, the flow rate can be estimated based on the pressure, instead of directly detecting the flow rate.

In the fuel cell power generation system, the object subjected to degradation determination may be at least one of an oxidizing agent supply device that supplies an oxidizing gas to the fuel cell and a fuel supply device that supplies a fuel to the fuel cell (claim 6). In such a configuration, the flow rate deficiency of the oxidizing agent or the fuel can be inhibited.

The fuel cell power generation system may further comprise a fuel processor that generates a fuel from water and a material; wherein the object subjected to degradation determination is at least one of a water supply device that supplies water to the fuel processor and a material supply device that supplies a material to the fuel processor (claim 7). In such a configuration, the flow rate deficiency of the water or the material can be inhibited.

In the fuel cell power generation system, the operation control means may execute a limited operation so that the power output of the fuel cell becomes not more than an upper limit value of the power output of the fuel cell corresponding to the flow rate for determination, when it is determined that the flow rate for determination falls within the first degradation range (claim 8). In such a configuration, the power output can be changed according to the degradation, and thus, the flow rate deficiency can be inhibited surely and efficiently.

In the fuel cell power generation system, the first degradation range may be a range which causes economic advantage if the limited operation is continued, and the second degradation range may be a range which causes economic disadvantage if the limited operation is continued (claim 9). In such a configuration, the operation can be stopped only when the economic disadvantage may be caused, and thus the operation efficiency can be improved.

In the fuel cell power generation system, the second degradation range may be a range in which the upper limit value of the power output of the fuel cell corresponding to the flow rate for determination is less than a predetermined power output (claim 10). In such a configuration, it can be determined whether or not to stop the operation based on the limit power output, and thus a complex calculation for determination of economic efficiency may be omitted. As a result, it can be simply determined whether or not to stop the operation.

In the fuel cell power generation system, the second degradation range may be a range in which efficiency of the fuel cell is less than a predetermined efficiency (claim 11). In such a configuration, it can be determined whether or not to stop the operation based on the efficiency, and thus a complex calculation for determination of economic efficiency may be omitted. As a result, it can be simply determined whether or not to stop the operation.

The fuel cell power generation system may further comprise a storage means that stores a rate structure of electric power and/or material; and a cost calculating means that calculates supply cost of at least one of the electric power and heat supplied from the fuel cell power generation system and supply cost of at least one of electric power and heat supplied from an alternative means based on a predetermined rate structure of the electric power and the material; wherein the second degradation range is a range in which the supply cost of the alternative means is less than the supply cost of the fuel cell power generation system (claim 12). In such a configuration, determination of economic efficiency can be executed using the actual costs, and thus the efficiency can be further improved.

The fuel cell power generation system may, further comprise a communication means that obtains a current rate structure of the electric power and/or the material through communication; wherein the rate structure stored in the storage means may be updated to the rate structure obtained by the communication means (claim 13). In such a configuration, parameters for cost calculation can be updated as required, and thus determination using more correct costs is achieved. The fuel cell power generation system may further comprise an operation time integrating means that integrates an operation time of the fuel cell power generation system; a display means that displays information of the fuel cell power generation system; and a time predicting means that predicts a time period that elapses until a detection value that is detected by the flow rate detecting means reaches the first degradation range and/or the second degradation range, based on the output command value given by the flow rate control means, the detection value detected by the flow rate detecting means, and the operation time integrated by the operation time integrating means; wherein the display means may display the time period predicted by the time predicting means (claim 14). In such a configuration, the user is able to be informed that when the degradation will occur, and thus maintenance becomes easy.

The fuel cell power generation system may further comprises a maintenance notification means which notifies that maintenance of the object subjected to degradation determination is needed when a detection value falls within the first degradation range (claim 15). The fuel cell power generation system may in some cases serve as a life line as a means for supplying the electric power to home, etc. If the operation is stopped at the time point when severe failure has actually occurred in the fuel cell power generation system, then supply of the electric power is suddenly stopped, which severely affects home life, etc. In order to operate the fuel cell power generation system economically and stably, it is necessary to repair or change a pump, etc in an earlier state, and so on. In accordance with the above mentioned configuration, it is possible to notify a manager that maintenance of the fluid supply device is needed when it has been determined that the degradation has occurred in the fluid supply device.

The above and further objects and features of the invention will be more fully be apparent from the following detailed description with accompanying drawings.

### Effects of the Invention

The present invention has the construction as described above, and provides a fuel cell power generation system configured to execute operation control so as to ensure economic efficiency depending on the degree of degradation or abnormality of fluid supply devices that is associated with the fuel cell power generation system, for example, cooling water of a fuel cell.

### BRIEF DESCRIPTION OF THE DRAWINGS

FIG. 1 is a block diagram schematically showing a construction of a fuel cell power generation system according to a first embodiment of the present invention;

FIG. 2 is a block diagram schematically showing a configuration of a controller according to the first embodiment of the present invention;

FIG. 3 is a view showing a relationship between a flow rate of reforming water and a power output in the fuel cell power generation system according to the first embodiment of the present invention;

FIG. 4 is a view showing a relationship between an output command value given to a reforming water supply device and the flow rate of the reforming water in the fuel cell power generation system according to the first embodiment of the present invention;

FIG. 5 is a view showing a relationship between an output command value given to the reforming water supply device and the flow rate of the reforming water in a case where degradation has occurred in the reforming water supply device in the fuel cell power generation system according to the first embodiment of the present invention;

FIG. 6 is an example of a table that is used to determine whether or not first degradation has occurred and to carry out a limited operation in the fuel cell power generation system according to the first embodiment of the present invention;

FIG. 7 is a graph showing a power generation amount of the fuel cell power generation system in a normal state with respect to a power load at a standard home, in the fuel cell power generation system according to the first embodiment of the present invention;

FIG. 8 is a graph showing a power generation amount of the fuel cell power generation system with respect to the power load at the standard home, in a case where degradation has occurred in a fluid supply device in the fuel cell power generation system according to the first embodiment of the present invention;

FIG. 9 is a view schematically showing a relationship between the power output and efficiency in the fuel cell power generation system according to the first embodiment of the present invention;

FIG. 10 is a view schematically showing a relationship between a limit power output with respect to the power load at the standard home and cost advantage in the fuel cell power generation system according to the first embodiment of the present invention;

FIG. 11 is a block diagram schematically showing a construction of a fuel cell power generation system according to a second embodiment of the present invention;

FIG. 12 is a block diagram schematically showing a configuration of a controller according to the second embodiment of the present invention;

FIG. 13 is a view showing a relationship between a flow rate of cooling water and a power output in the fuel cell power generation system according to the second embodiment of the present invention;

FIG. 14 is a view showing a relationship between an output command value given to a cooling water supply device and the flow rate of the cooling water in the fuel cell power generation system according to the second embodiment of the present invention;

FIG. 15 is a view showing a relationship between an output command value given to the cooling water supply device and the flow rate of the cooling water in a case where degradation has occurred in the cooling water supply device in the fuel cell power generation system according to the second embodiment of the present invention;

FIG. 16 is a view showing a relationship between an output command value given to the cooling water supply device and the flow rate of the cooling water in a case where degradation of the cooling water supply device progresses in the fuel cell power generation system according to the second embodiment of the present invention;

FIG. 17 is a block a diagram schematically showing a construction of a fuel cell power generation system according to a third embodiment of the present invention;

FIG. 18 is a conceptual diagram showing a method to predict an upper limit of an achievable cooling water flow rate in the third embodiment of the present invention;

FIG. 19 is a conceptual diagram showing a method to determine whether or not degradation has occurred in a fourth embodiment of the present invention; and

FIG. 20 is a view showing a construction of the conventional fuel cell power generation system.

### EXPLANATION OF REFERENCE NUMERALS

11 fuel cell
12 fuel processor
13 burner
14 reforming water supply device
15 material supply device
16 oxidizing agent supply device
17 cooling water supply device
18 reforming water flow rate detecting means
19 material flow rate detecting means
20 oxidizing agent flow rate detecting means
21 cooling water flow rate detecting means
22 controller
23 maintenance notification means
24 flow rate control means
25 degradation determination means
26 operation control means
27 control unit
28 storage unit
29 state storage means
30 communication means
31 economic efficiency determination means

### BEST MODE FOR CARRYING OUT THE INVENTION

Hereinafter, preferred embodiments of the present invention will be described with reference to the drawings.

### EMBODIMENT 1

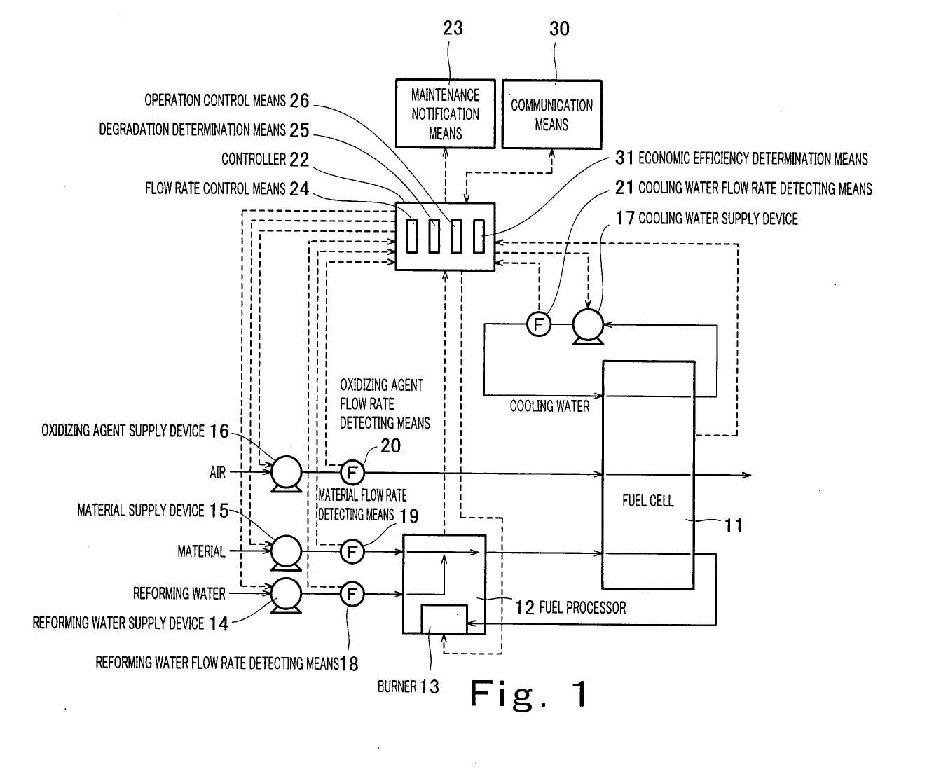

FIG. 1 is a block diagram schematically showing a construction of a fuel cell power generation system according to a first embodiment of the present invention. Hereinbelow, hardware and a control system in the fuel cell power generation system of this embodiment will be respectively described with reference to FIG. 1.

First, the hardware will be described. As shown in FIG. 1, the hardware of this embodiment includes a fuel cell 11 that generates electric power through an electrochemical reaction using a fuel and an oxidizing agent such as air which are supplied, a fuel processor 12 that generates a gas containing hydrogen through a reforming reaction occurring between a supplied material such as a natural gas and steam generated by heating supplied reforming water and to supply the gas to the fuel cell 11 as a fuel, a burner 13 that combusts the fuel (hereinafter referred to as an off gas) that is unconsumed and exhausted from the fuel cell 11 to heat the fuel processor 12, a reforming water supply device 14 that supplies the reforming water to the fuel processor 12, a material supply device 15 that supplies the material to the fuel processor 12, an oxidizing agent supply device 16 that supplies an oxidizing agent to the fuel cell 11, and a cooling water supply device 17 configured to supply cooling water to the interior of the fuel cell 11 to cool the interior of the fuel cell 11 to thereby maintain a temperature suitable for a reaction. The reforming water supply device 14, the material supply device 15, the oxidizing agent supply device 16 and the cooling water supply device 17 are the fluid supply device recited in claims.

In this embodiment, as the material, the natural gas is used, as the reforming water and the cooling water, ion-exchanged water is used, and as the oxidizing agent, air is used. As the reforming water supply device 14, the material supply device 15, the oxidizing agent supply device 16, and the cooling water supply device 17, for example, a blower or a pump is used depending on uses. As the blower, for example, a turbo blower, a scroll blower, a sirocco fan, or the like is used. As the pump, for example, a plunger pump, a diaphragm pump, a centrifugal pump, or the like is used. As the burner 13, for example, a flame burner is used. Whereas in this embodiment, the off gas exhausted from the fuel cell 11 is mixed with air and combusted in the burner 13, the material may alternatively be used as a combustion fuel instead of the re-use of the off gas.

Next, the control system will be described. As shown in FIG. 1, the control system of this embodiment includes a reforming water flow rate detecting means 18 that detects the flow rate of the reforming water, a material flow rate detecting means 19 that detects the flow rate of the material, an oxidizing agent flow rate detecting means 20 that detects the flow rate of the air which is the oxidizing agent, a cooling water flow rate detecting means 21 that detects the flow rate of the cooling water, a flow rate control means 24 that gives output command values to the reforming water supply device 14, the material supply device 15, the oxidizing agent supply device 16, and the cooling water supply device 17 to control the flow rate of the reforming water, the flow rate of the material, the flow rate of the oxidizing agent, and the flow rate of the cooling water, a degradation determination means 25 that determines whether or not degradation has occurred in the objects subjected to degradation determination which are the reforming water supply device 14, the material supply device 15, the oxidizing agent supply device 16, and the cooling water supply device 17, an operation control means 26 that controls an operation of the fuel cell power generation system, an economic efficiency determination means 31 that determines economic efficiency of the operation of the fuel cell power generation system, a maintenance notification means 23 that notifies a need for maintenance of the supply device that has been determined to have been degraded, and a communication means 30 that obtains data used to determine economic efficiency. In this embodiment, the flow rate control means 24, the degradation determination means 25, the operation control means 26, and the economic efficiency determination means 31 are implemented by a controller 22 in centralized and software manner. Alternatively, the respective control means may be implemented in a distributed manner. That is, the flow rate control means 24, the degradation determination means 25, the operation control means 26, and the economic efficiency determination means 31 may be respectively equipped with controllers. In the interior of the fuel cell 11 and the interior of the fuel processor 12, temperature detecting means (e.g., thermocouple, a detail of which is not shown in Figures) are attached to detect their respective internal temperatures. The reforming water flow rate detecting means 18, the material flow rate detecting means 19, the oxidizing agent flow rate detecting means 20, and the cooling water flow rate detecting means 21 are fluid flow rate detecting means recited in claims.

In this embodiment, as the reforming water flow rate detecting means 18, the material flow rate detecting means 19, the oxidizing agent flow rate detecting means 20, and the cooling water flow rate detecting means 21, for example, a vane wheel type flow meter or a mass flow sensor is used. As the controller 22, for example, a microcomputer is used. As the maintenance notification means 23, for example, a buzzer or a display is used. As the communication means 30, for example, an input/output circuit that is capable of being coupled to communication networks such as a radio, a telephone line, or Internet is used.

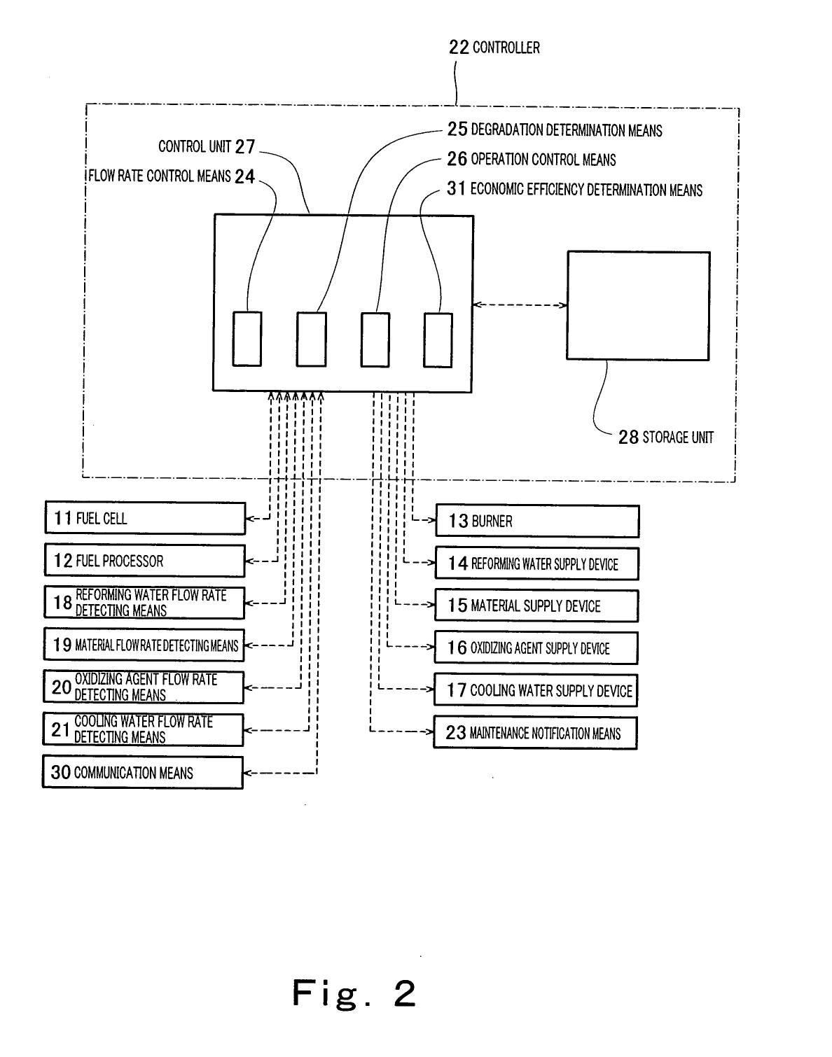

Below, a configuration of the controller 22 will be described. FIG. 2 is a block diagram schematically showing the configuration of the controller 22. The controller 22 includes a control unit 27 and a storage unit 28. As the control unit 27, for example, a CPU is used. As the storage unit 28, for example, an internal memory is used. The control unit 27 receives detection signals of objects to be detected, from respective of the sensors or the like such as the temperature detecting means attached on the fuel cell 11 and the fuel processor 12, the reforming water detecting means 18, the material flow rate detecting means 19, the oxidizing agent flow rate detecting means 20, and the cooling water flow rate detecting means 21. In addition, the control unit 27 receives, though the communication means 30, information of rate structure of electricity or material, and so on from a power company, a gas company or the like. Furthermore, the control unit 27 executes the software stored in the storage unit 28 to process the received signals, and, based on the result, sends control signals to the objects to be controlled such as the burner 13, the material supply device 15, the reforming water supply device 14, the oxidizing agent supply device 16, and the cooling water supply device 17, and the maintenance notification means 23. Thereby, the temperature of the fuel cell 11 or the fuel processor 12, the flow rates or the like of the material, the fuel and the reforming water are controlled.

Subsequently, an operation of the controller 22 will be described with reference to FIG. 2. The storage unit 28 contains control programs and set values or the like for use in the control programs. The control unit 27 reads out the control program from the storage unit 28 and executes it. Thereby, the operation takes place as follows. Signals indicating detection values of amounts to be controlled such as the temperature and the flow rate that have been detected by the sensors or the like are sent to the control unit 27. The control unit 27 causes the storage unit 28 to store the detection values as necessary. The control unit 27 calculates control target values or the like of the objects to be controlled, using the set values, the detection values, and so on which are stored in the storage unit 28. In addition, the control unit 27 rewrites the set values, the control target values which are stored in the storage unit 28, etc, based on a calculation result, as required. Furthermore, the control unit 27 gives the output command values to the objects to be controlled. More specifically, the control unit 27 sends signals indicating the output command values to the objects to be controlled. By the above mentioned operation, the controller 22 detects and controls the values of the amounts to be controlled, and causes the fuel cell power generation system to operate. Among these functions of the controller 22, specified functions described later are referred to as the flow rate control means 24, the degradation determination means 25, and the operation control means 26.

Regarding the operation of the fuel cell power generation system of this embodiment configured as described above, the outline of an operation during a normal operation will be first described.

Initially, the reforming water and the material are respectively supplied from the reforming water supply device 14 and the material supply device 15 to the fuel processor 12. The reforming water supplied to the fuel processor 12 is evaporated into steam by heat supplied from the burner 13. The steam and the supplied material go through a reforming reaction to generate the gas containing hydrogen in the interior of the fuel processor 12. Heat required for the reforming reaction to occur is supplied from the burner 13. The gas containing hydrogen is supplied from the fuel processor 12 to the fuel cell 11. The air, which is the oxidizing agent, is supplied from the oxidizing agent supply device 16 to the fuel cell 11. In the fuel cell 11, electric power is generated through an electrochemical reaction using the supplied fuel and oxygen contained in the supplied air. Cooling water supplied from the cooling water supply device 17 flows to remove excess heat in the interior of the fuel cell 11.

The controller 22 monitors and controls the temperature in the interior of the fuel cell 11 or in the interior of the fuel processor 12, and the flow rates or the like of the air, the material, the reforming water, and the cooling water, according to an operation pattern pre-stored or so as to achieve a power output that meets an electric power demand, thus operating the fuel cell power generation system.

Subsequently, the operation for executing flow rate control of the fluid during the normal state will be described. By way of example, the control of the flow rate of the reforming water (a reforming water flow rate) will be described below, but flow rates of other fluids are controlled in a similar manner.

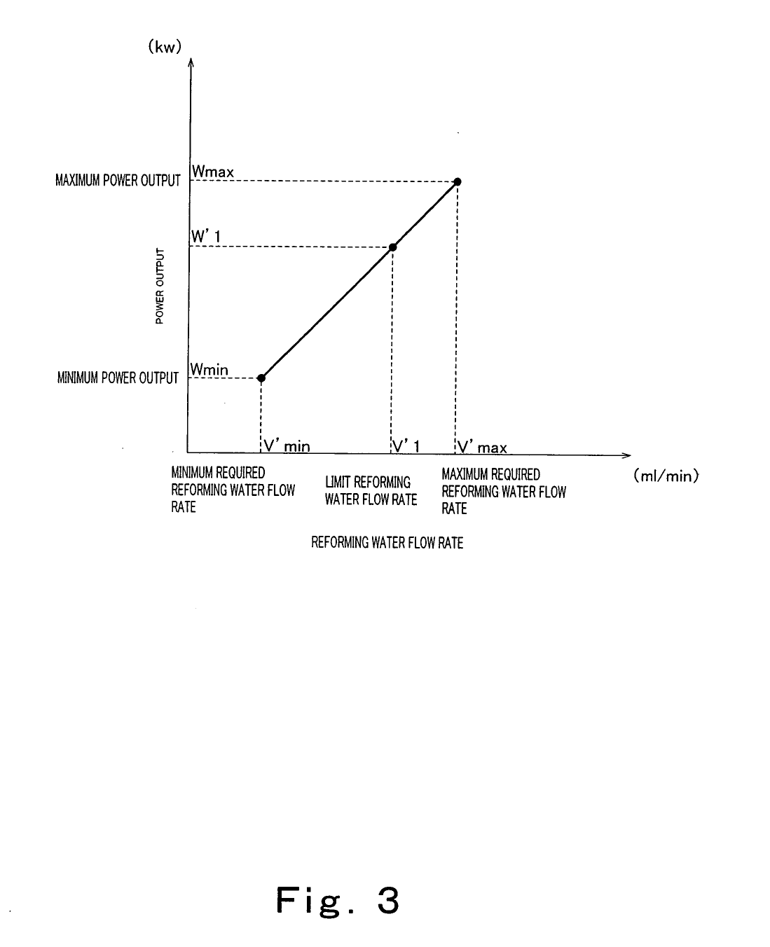

FIG. 3 is a conceptual diagram showing a relationship between the power output and a required flow rate of reforming water (hereinafter referred to as required reforming water flow rate). Whereas the relationship between the power output and the required reforming water flow rate is indicated by a straight line as described below, it may alternatively be indicated by a curve, etc. As shown in FIG. 3, the required reforming water flow rate changes as the power output changes. The operation control means 26 calculates a control target value of the reforming water flow rate that meets the required power output with reference to the relationship, and gives the control target value to the flow rate control means 24.

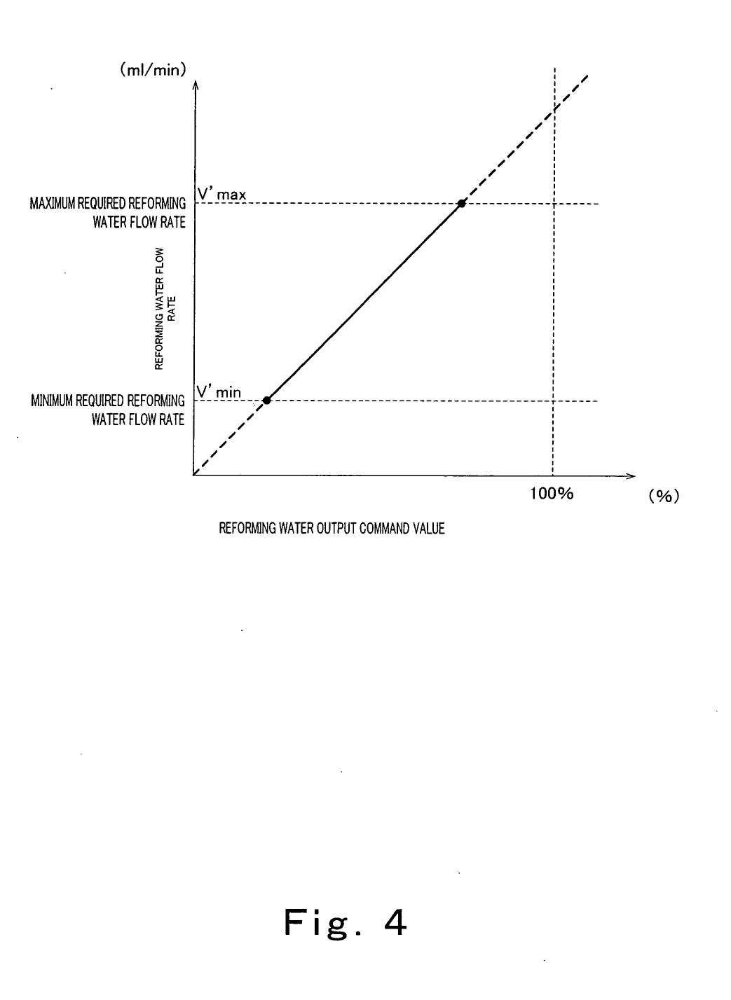

FIG. 4 is a conceptual diagram showing a relationship between an output command value (hereinafter referred to as a reforming water output command value) given to the reforming water supply device 14 and the reforming water flow rate. Whereas the relationship between the reforming water output command value and the reforming water flow rate is described below as indicated by a straight line, it may alternatively be indicated by a curve, etc. As shown in FIG. 4, the reforming water flow rate changes as the reforming water output command value changes. By utilizing this relationship, the flow rate control means 24 controls the reforming water flow rate to obtain the control target value of the required reforming water flow rate. In this embodiment, flow rate control of the reforming water is executed by feedback control. To be specific, the flow rate control means 24 monitors a detection value (hereinafter referred to as a detection value of the reforming water flow rate) which is sent from the reforming water flow rate detecting means 18 and controls the reforming water output command value until the control target value is achieved. It should be noted that the flow rate control of the reforming water may be executed by feedforward control if the reforming water supply device 14 outputs the reforming water in a specified amount with high precision in response to a specified reforming water output command value. In this case, the reforming water flow rate detecting means 18 is irrelevant to the control of the reforming water flow rate in a normal state. Furthermore, the feedforward control may be executed in the normal state, and the feedback control may be executed only when it is determined that degradation has occurred in the reforming water supply device 14.

As shown in FIG. 3, the power output which is capable of being supplied from the fuel cell power generation system ranges from a minimum value (hereinafter referred to as a minimum power output) Wmin to a maximum value (hereinafter referred to as a maximum power output) Wmax. Correspondingly, the required reforming water flow rate ranges from a minimum value (hereinafter referred to as a minimum required reforming water flow rate) V′min to a maximum value (hereinafter referred to as a maximum required reforming water flow rate) V′max. In contrast, the output command value given to the reforming water supply device 14 is limited in magnitude. If the output command value that exceeds an upper limit is given to the reforming water supply device 14, the flow rate does not change, or otherwise breakdown may occur in the reforming water supply device 14 because of an excessive load. For this reason, when the required reforming water flow rate is large, the control target value of the reforming water flow rate cannot in some cases be achieved even if the output command value is increased up to the upper limit. However, as shown in FIG. 4, the system is configured so that the reforming water flow rate becomes equal to the maximum required reforming water flow rate V′max without increasing the output command value up to the upper limit during the normal operation.

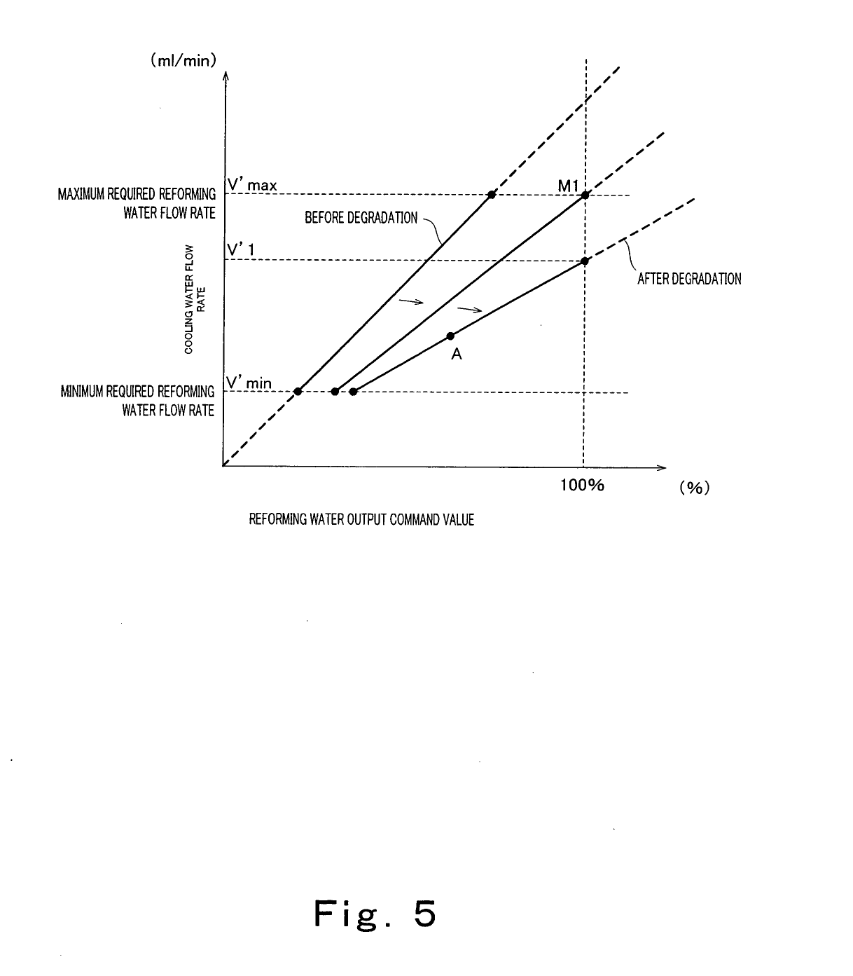

After a long time use of the reforming water supply device 14, degradation, for example, leakage in the passage or clogging in a filter attached to an inlet tends to occur. FIG. 5 is a conceptual diagram showing a relationship between the reforming output command value and the reforming water flow rate in a case where such degradation has occurred. As shown in FIG. 5, with progress of degradation, a line indicating the relationship between the reforming water output command value and the reforming water flow rate shifts, and the reforming water flow rate increases up to but does not exceed V′1 and does not become equal to the maximum required reforming water flow rate V′max, even if the reforming water output command value is increased up to the upper limit. Hereinbelow, the upper limit of an achievable reforming water flow rate is referred to as a limit reforming water flow rate. As shown in FIG. 3, when the reforming water flow rate increases up to but does not exceed the limit reforming water flow rate V′1, the power output increases up to but does not exceed W′1, and it is thus unable to achieve the maximum power output Wmax. Under this condition, if an attempt is made to increase the power output beyond W′1, deficiency of the reforming water flow rate occurs, causing a catalyst in the fuel processor 12 to be degraded and damaged.

Thus far, the flow rate control of the reforming water has been described. Similarly, there is a correlation between the flow rate and the power output, in the material, the cooling water, and the oxidizing agent, and the required flow rate changes according to the power output. Also, if the maximum value of the required flow rate cannot be achieved because of degradation of the respective supply devices, then the maximum power output Wmax cannot be achieved as well. Under this condition, if an attempt is made to increase the power output up to more than the power output corresponding to the upper limit of the flow rate that is capable of being supplied, deficiency of the flow rate occurs, leading to problems that the interior of the fuel processor 12 is filled with excess water or soot originating from an excess material is deposited in the passage and clogs the passage.

A characteristic configuration of the fuel cell power generation system of this embodiment will be described. In this characteristic configuration, it is assumed that the reforming water supply device 14, the material supply device 15, the oxidizing agent supply device 16, and the cooling water supply device 17 are the objects subjected to degradation determination. The degradation determination means 25 determines whether or not degradation (hereinafter referred to as first degradation) which may cause a need to decrease the power output to avoid the flow rate deficiency has occurred in the objects subjected to degradation determination, based on the output command value given by the flow rate control means 24 and the corresponding detection value from the fluid flow rate detecting means. If it is determined that the first degradation has occurred, then the operation control means 26 limits the power output and controls the operation of the fuel cell power generation system so that the power output W′1 corresponding to V′1 becomes the upper limit of the power output (hereinafter referred to as a limit power output). Simultaneously, the maintenance notification means 23 notifies the manager that maintenance is needed.

As the degradation of the objects subjected to degradation determination progresses, power generation efficiency or safety in the whole system degrades. For this reason, the degradation determination means 25 determines whether or not degradation (hereinafter referred to as second degradation) which may cause economic disadvantage has occurred in the objects subjected degradation determination if the operation is continued, based on the output command value sent from the flow rate control means 24 and the corresponding detection value from the fluid flow rate detecting means. If it is determined that the second degradation has occurred in the object subjected to degradation determination, then the operation control means 26 causes the fuel cell power generation system to stop the operation.

Below, these operations will be described in detail. Below, the operation performed when degradation has occurred in the reforming water supply device 14 will be described. As a matter of course, similar operation may take place for the case of the cooling water supply device 17, the material supply device 15, and the oxidizing agent supply device 16.

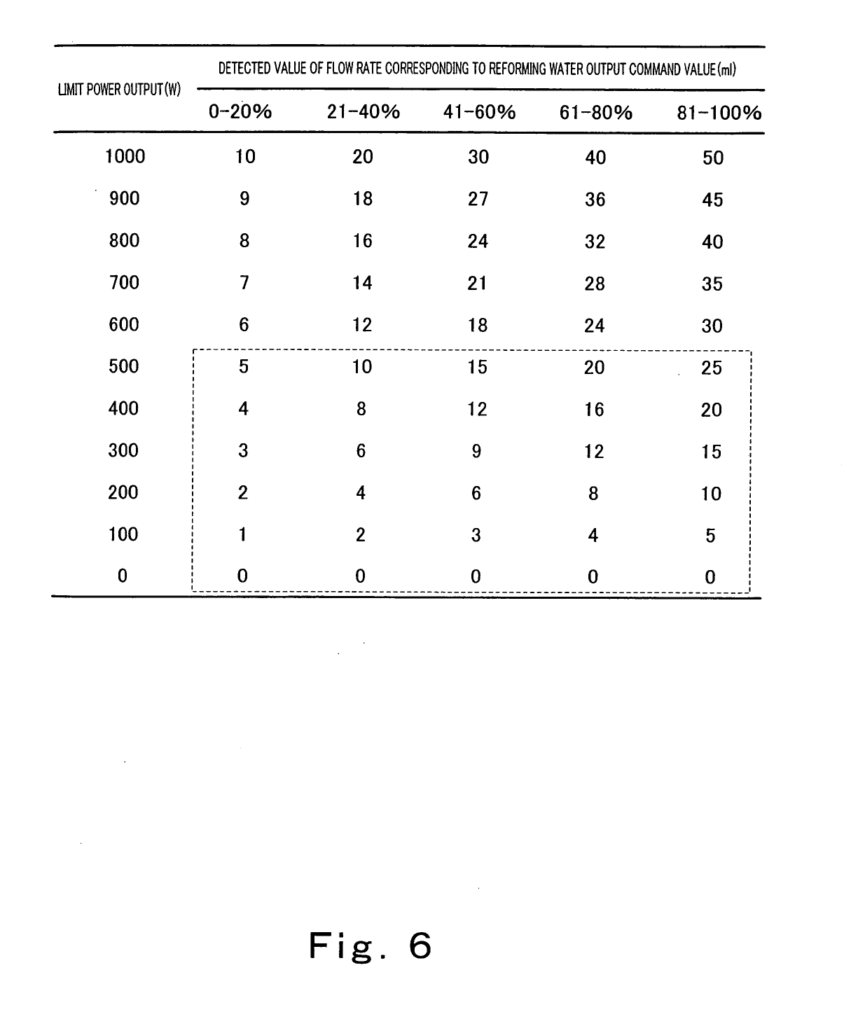

First, a method of determining whether or not the first degradation has occurred in the reforming water supply device 14 will be described. In the description below, it is assumed that the maximum power output is 1000 W. In this embodiment, it is determined whether or not the first degradation has occurred in the reforming water supply device 14 with reference to a table. FIG. 6 is a view illustrating an example of the table that is used to determine whether or not the first degradation has occurred and to perform a limited operation (operation in which the power output less than the maximum power output is the limit power output). The table illustrates what thresholds of the flow rates are to enable the normal operation (operation in which the maximum power output is the limit power output) when the reforming water output command value falls within predetermined ranges. In addition, the table illustrates values of the limit power output to be set according to the detection values of the flow rate when the reforming water output command value falls within the predetermined ranges.

The degradation determination means 25 receives the reforming water output command value from the flow rate control means 24 and receives the detection value of the reforming water flow rate from the reforming water flow rate detecting means 18. Using the received command value and detection value and the table of FIG. 6, the degradation determination means 25 determines whether or not the first degradation has occurred in the reforming water supply device 14 and sets the limit power output.

If a detected flow rate (flow rate for determination) corresponding to a predetermined output command value is above a flow rate corresponding to the limit power output 1000 W, then it is determined that the degradation has not occurred. For example, when the output command value is 40% and the detection value of the flow rate is 22 ml/min, which is more than the flow rate (20 ml/min) of the limit power output 1000 W corresponding to the output command value 40%, it is determined that the first degradation has not occurred, and thus the normal operation is continued.

If the detected flow rate corresponding to the predetermined output command value is below the flow rate corresponding to the limit power output 1000 W, then it is determined that the first degradation has occurred, and thus the power output corresponding to that flow rate is set as the limit power output. For example, when the output command value is 60% and the detection value of the flow rate is 23 ml/min, which is less than the flow rate (30 ml/min) of the limit power output 1000 W corresponding to the output command value 60%, it is determined that the first degradation has occurred. Also, since the detection value of the flow rate is not less than 21 and less than 24, the corresponding power output 700 W is set as the limit power output W′1.

If it is determined that the first degradation has occurred in the reforming water supply device 14, this is communicated to the operation control means 26 and the maintenance notification means 23. The operation control means 26 sets the power output W′1 as the upper limit of the power output and causes the fuel cell power generation system to continue the operation (limited operation) with a power output that does not exceed the power output W′1. The maintenance notification means 23 notifies the manager that maintenance is needed.

By the above mentioned operation, the fuel cell power generation system of this embodiment is able to continue the operation while inhibiting the flow rate deficiency and to notify the manager that maintenance of the reforming water supply device 14 is needed, under the condition the first degradation has occurred in the reforming water supply device 14.

After it is determined that the first degradation has occurred in the reforming water supply device 14, the degradation of the reforming water supply device 14 may progress unless the maintenance is carried out. As the degradation progresses, the limit reforming water flow rate V′1 decreases. In this embodiment, the degradation determination means 25 changes the limit power output as required based on the output command value and the detection value of the flow rate. Thereby, the decreased power output can be changed suitably according to the progress of the degradation, and power generation can be carried out stably.

Subsequently, a method of determining whether or not second degradation has occurred in the reforming water supply device 14 will be described. In this embodiment, the economic efficiency determination means 31 determines whether or not the second degradation has occurred in the reforming water supply device 14. Hereinafter, an operation of the economic efficiency determination means 31 will be described in detail.

In this embodiment, in a case where electric power is not generated in and not supplied from the installed fuel cell power generation system in response to electric power demand, it is purchased from a commercial power supply (not shown). By comparing a cost necessary to supply the electric power from the fuel cell power generation system to a cost necessary to purchase the electric power from the commercial power supply, with respect to desired electric power, economic advantage or disadvantage is determined. The economic efficiency determination means 31 decides, based on the rate structure of the electricity and the material which are pre-stored in the storage unit 28, a power output range in which the cost of the power supply from the fuel cell power generation system is higher than the cost of the purchase of the electric power from the commercial power supply (i.e., power generation in the fuel cell power generation system is economically disadvantageous as compared to the purchase of the electric power from the commercial power supply), and sets the corresponding reforming water flow rate as a range of the second degradation. The economic efficiency determination means 31 determines economic efficiency in real time in view of an operation time period, an amount of stored hot water (in a cogeneration system in which the fuel cell power generation system supplies heat), etc. The communication means 30 may update, as required, information regarding the rate structure of the electric power and the material which are stored in the storage unit 28. The economic efficiency determination means 31 may simply determine economic efficiency in such a manner that the power output and efficiency which are less than predetermined values are the second degradation range.

The economic efficiency determination means 31 calculates the cost of the purchase of the electric power from the commercial power supply and the cost of the supply of the electric power from the fuel cell power generation system based on the rate structures of the electric power and the material which are stored in the storage unit 28 and according to the following formula. Below, a predetermined power generation amount by the fuel cell is assumed as a reference amount.
Commercial power supply cost (yen)=power generation amount (kWh)×electric utility rate (yen/kWh) (1)
Fuel cell cost (yen)=power generation amount (kWh)×material consumption amount per unit power generation amount (m³/kWh)×material rate (yen/m³) (2)

In a case where the fuel cell power generation system is a cogeneration system, hot water supply is possible during power generation. The cost of hot water supply in the fuel cell power generation system is included in the fuel cell cost. On the other hand, when the electric power is purchased from the commercial power supply, the cost of hot water supply (hereinafter referred to as a commercial hot water supply cost) is necessary in addition to the electric power cost. When an electric water heater is used to supply hot water, the commercial hot water supply cost is calculated according to the following formula:
Commercial hot water supply cost (yen)=power generation amount (kWh)×hot water supply amount per unit power generation amount (kcal/kWh)×hot water supply efficiency (kWh/kcal) of electric water heater×electric utility rate (yen/kWh) (3)

When a gas water heater is used to supply hot water, the commercial hot water supply cost is calculated according to the following formula:
Commercial hot water supply cost (yen)=power generation amount (kWh)×hot water supply amount per unit power generation amount (kcal/kWh)×hot water supply efficiency (m³/kcal) of gas water heater×gas rate (yen/m³) (3′)

The economic efficiency determination means 31 compares the cost of the fuel cell power generation system to the cost of the commercial power supply to determine economic advantage or disadvantage. When the fuel cell power generation system does not supply hot water, cost advantage is calculated according to the following formula:
Cost advantage=commercial power supply cost−fuel cell cost (4)

When the fuel cell power generation system supplies hot water (i.e., the fuel cell power generation system is the cogeneration system), cost advantage is calculated according to the following formula:
Cost advantage=commercial power supply cost+commercial hot water supply cost−fuel cell cost (4′)

If the cost advantage is minus, it is determined that the fuel cell power generation system causes economic disadvantage as compared to the commercial power supply. The timing when this determination is made may be various. For example, two types of timings are possible. One timing is such that the cost is calculated from power generation amount and material consumption amount at that moment at predetermined time (every minute, every second, etc) intervals. In this method, if the cost advantage is minus even for a moment, then it is determined that the second degradation has occurred, and the operation is stopped. Another timing is such that the cost at that moment is integrated at predetermined time (one day or one week) intervals and an integrated value of the commercial power supply cost is compared to an integrated value of the fuel cell cost to determine economic efficiency. According to this method, the operation can be continued when the operation brings about economic advantage in a whole predetermined time period even when it brings about economic disadvantage at a moment. In the latter method, the operation can be continued for a longer time period.

The relationship between degradation of the reforming water supply device 14 and the cost will now be described. As the degradation of the reforming water supply device 14 progresses, the limit power output is set to less than the maximum power output and the operation is continued as described above. In general, efficiency decreases as the limit power output decreases. As the degradation progresses, the limit power output decreases, and the material consumption amount per unit power generation amount and the fuel cell cost in the formula (2) increase. By using the formula (4) or the formula (4′), the relationship between the limit power output and the cost advantage can be found in real time. The limit power output corresponds to the limit reforming water flow rate. Therefore, when the limit reforming water flow rate is less than a flow rate corresponding to a power output (hereinafter referred to as critical power output) in which the cost advantage is zero, the operation of the fuel cell power generation system causes economic disadvantage if the operation is continued, and therefore, the operation is stopped. That is, the range of a flow rate in which the limit reforming water flow rate is less than the flow rate corresponding to the critical power output is the second degradation range. For example, assuming that the critical power output is 500 W, a range in which the reforming water flow rate is less than a flow rate corresponding to the power output 500 W with respect to the respective output command values (range defined by a broken line in FIG. 6) is the second degradation range. If a detected reforming water flow rate (determined flow rate) corresponding to a predetermined output command value given falls within the second degradation range, then the operation is stopped.

In the above configuration, since the cost advantage fluctuates in real time depending on the rate structure of the electricity or the material or the operation time period, the second degradation range fluctuates correspondingly in real time. Alternatively, it may be determined that the second degradation has occurred when the power output or the efficiency is less than a preset value. The preset value is decided as follows.

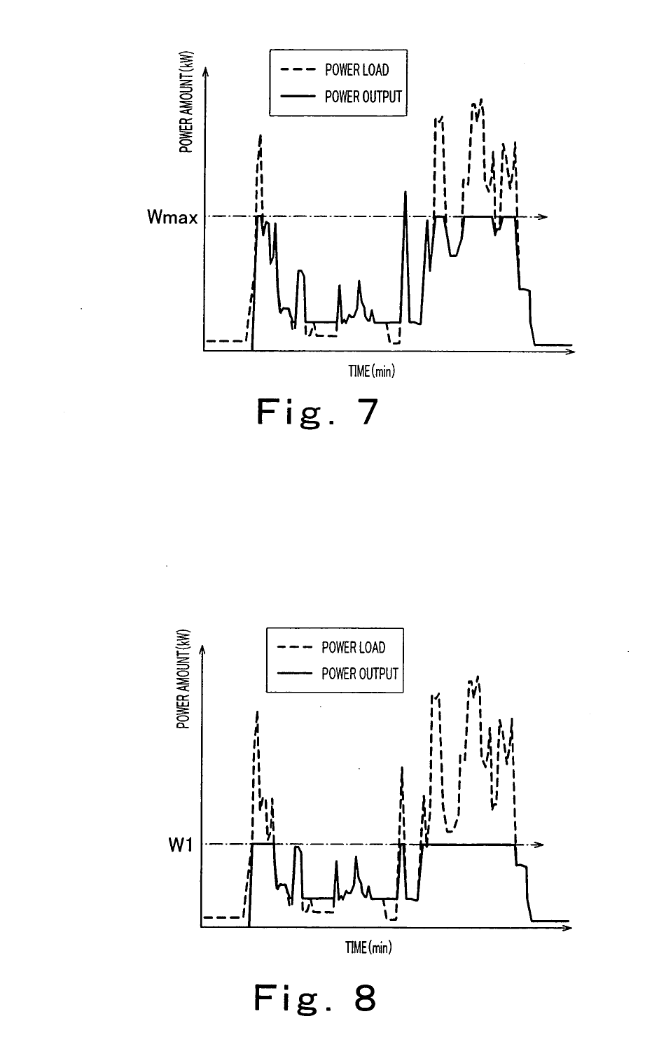

FIG. 7 is a graph showing the power generation amount in the fuel cell power generation system in the normal state with respect to the power load at standard home. FIG. 8 is a graph showing a power generation amount in the fuel cell power generation system with respect to the power load at the standard home when degradation has occurred in the fluid supply device. As shown in FIG. 7, the fuel cell power generation system carries out a power load responsive operation that generates electric power according to a home load within an allowable power generation amount range. When the system falls within the first degradation range, the limit power output is lower than the maximum power output, and therefore the power generation amount becomes as illustrated in FIG. 8.

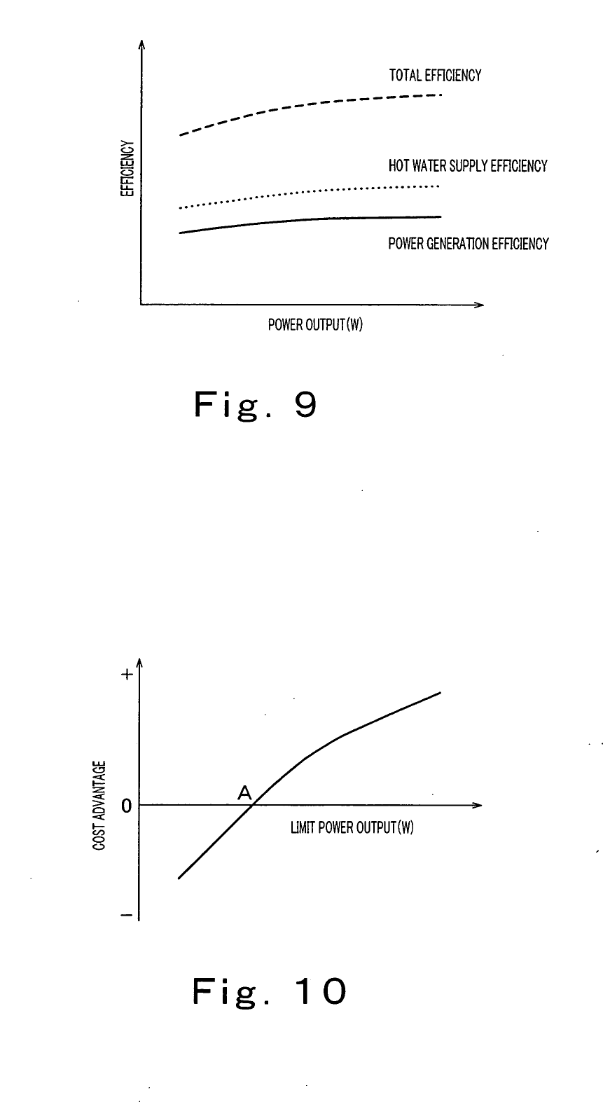

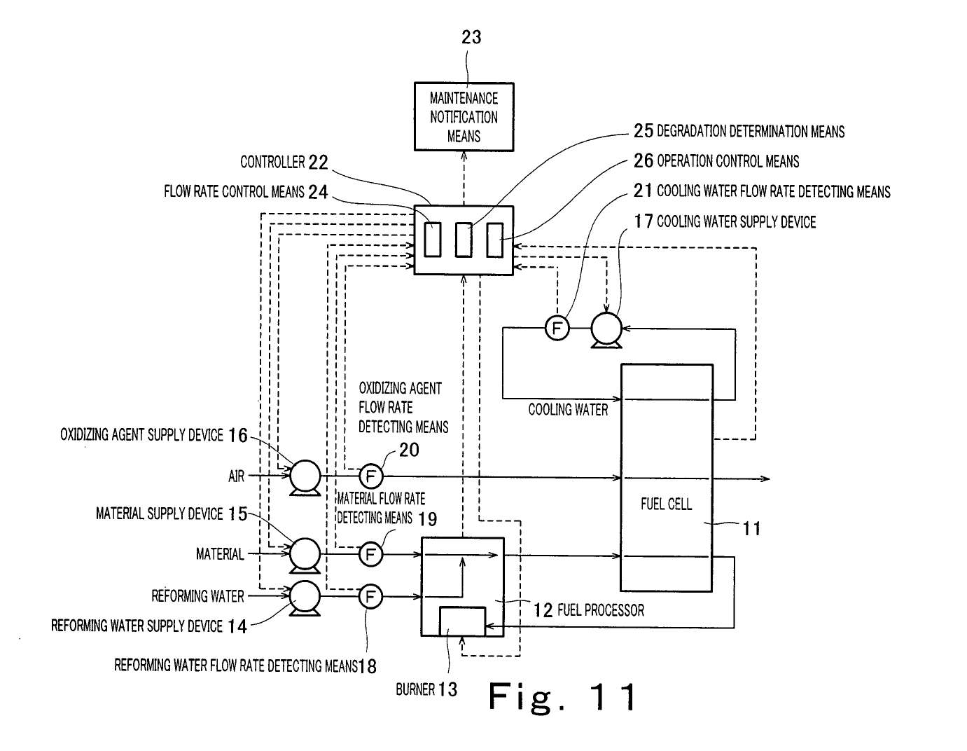

FIG. 9 is a view showing a schematic relationship between the power output and the efficiency. For example, in a fuel cell power generation system capable of outputting its power output in a range of 300 to 1000 W, a loss due to heat radiation, an energy necessary to operate actuators, etc, do not substantially change, regardless of whether the power output is 1000 W or 300 W. In general, the efficiency decreases as the power output decreases in the fuel cell power generation system, because of energy consumption required without depending on the power output.

As used herein, the term “efficiency” refers to a ratio between an energy (material) required to operate the system and an energy (electricity and hot water in the cogeneration system) output from the system:
Electric energy÷material energy=power generation efficiency,
heat energy÷city gas (material) energy=heat efficiency (hot water supply efficiency),
power generation efficiency+hot water supply efficiency=total efficiency.

Because the energy required to generate the same power output increases as the efficiency decreases, the economic disadvantage is caused.

FIG. 10 is a view showing a schematic relationship between the limit power output with respect to the power load at the standard home and the cost advantage. Turning to FIG. 10, a limit power output A corresponding to the cost advantage of zero or less is decided as a predetermined power output used to determine whether or not the reforming water flow rate falls within the second degradation range. The flow rate corresponding to the limit power output A is found. If the reforming water flow rate is not more than that flow rate, then it is determined that the reforming water flow rate falls within the second degradation range and therefore the operation of the fuel cell power generation system is stopped.

It can be determined whether or not the reforming flow rate falls within the second degradation range in a similar method using the efficiency. A graph is created with the efficiency on a horizontal axis and the cost advantage on a vertical axis, and a predetermined power output B used to determine whether or not the reforming water flow rate falls within the second degradation range is decided. A flow rate corresponding to the limit power output B is found. If the reforming water flow rate is not more than that flow rate, then it is determined that the reforming water flow rate falls within the second degradation range, and therefore, the operation of the fuel cell power generation system is stopped.

By the above mentioned operation, the fuel cell power generation system of this embodiment is able to stop the operation when the degradation has occurred in the reforming water supply device 14 and economic disadvantage arises. As a result, it is possible to inhibit continuation of the operation under the economically disadvantageous condition when the degradation has occurred in the reforming water supply device 14.

In the manner described above, occurrence of the degradation is determined in two stages, and the operation is continued with reduced power output when the degradation (first degradation) has occurred in the fluid supply device within the range in which the system is able to operate under the economically advantageous condition by reducing the power output, whereas the operation is stopped when the degradation (second degradation) has progressed to an extent that the continued operation brings about the economical disadvantages. In this manner, operation control capable of ensuring economic efficiency can be executed.

There has been a problem that if the operation is continued under the condition in which the flow rates of various fluids such as the cooling water are deficient, failure is likely to occur in the fluid supply devices other than the associated fluid supply device, the fuel cell, the reformer, etc, or catalyst or the like contained in the fuel cell, the reformer, etc is likely to be degraded. In accordance with the fuel cell power generation system of this embodiment, since the power output is reduced to avoid the flow rate deficiency against the degradation of the fluid supply device, degradation or failure of other components can be avoided.

Whereas in this embodiment, the flow meter is used as the reforming water flow rate detecting means 18, a pressure meter that detects a pressure of the reforming water or a velocity meter that detects a velocity of the reforming water may alternatively be equipped to determine whether or not it is necessary to reduce the power output or whether or not it is necessary to stop the operation based on the relationship between the output command value and the pressure or the velocity. In another alternative, the flow rate may be calculated (estimated) from the pressure or the velocity, and the above determination may be executed based on the resulting flow rate. Thereby, it is possible to continue the operation thereof with the reduced power output and to notify the manager that maintenance of the reforming water supply device 14 is needed, even when the flow rate is not directly detected. In addition, it is possible to stop the operation if the degradation of the reforming water supply device 14 progresses to an extent that economic disadvantage arises.

When degradation has occurred in the fluid supply devices other than the reforming water supply device 14, for example, the material supply device 15, the cooling water supply device 17, and the oxidizing agent supply device 16, similar effects are obtained by similar operations. As a result, against a situation where degradation has occurred in any of the fluid supply devices, it is possible to continue the operation thereof while inhibiting the flow rate deficiency and to notify the manager that maintenance of that fluid supply device is needed. In addition, it is possible to stop the operation if the degradation of that fluid supply device progresses to an extent that economic disadvantage arises.

To determine whether or not degradation has occurred in plural fluid supply devices, it is desirable that the maintenance notification means 23 have notification patterns differed for respective supply devices. This enables the manager to easily recognize time and objects of maintenance and thus to carry out maintenance of the fuel cell power generation system more efficiently.

If it is determined that the first degradation has occurred in the plural fluid supply devices in a case where it is determined whether or not the degradation has occurred in the plural fluid supply devices, it is desired that the fuel cell power generation system be operated with a power output which does not exceed a limit power output which is the lowest power output among power outputs corresponding to flow rates responsive to upper limit command values given to the respective fluid supply devices. As a result, against a situation where degradation has occurred in the plural fluid supply devices, it is possible to continue the operation while inhibiting the flow rate deficiency and to notify the manager that maintenance of the associated fluid supply devices is needed.

If it is determined that the second degradation has occurred in any one of the fluid supply devices in a case where it is determined whether or not the degradation has occurred in the plural fluid supply devices, it is desirable to stop the operation. As a result, in a case where maintenance is not carried out and the degradation of any of the fluid supply devices brings about economic disadvantage, the operation can be stopped.

### EMBODIMENT 2

In the first embodiment, it is determined whether or not the first degradation and second degradation have occurred in the objects subjected to degradation determination with reference to the table without executing control for achieving a maximum flow rate as a target value. In contrast, in the second embodiment, the degradation determination means 25 determines that the first degradation and the second degradation have occurred in the objects subjected to degradation determination if a required flow rate according to a control target value of the power output is unachievable although the control is actually attempted to achieve the required flow rate.

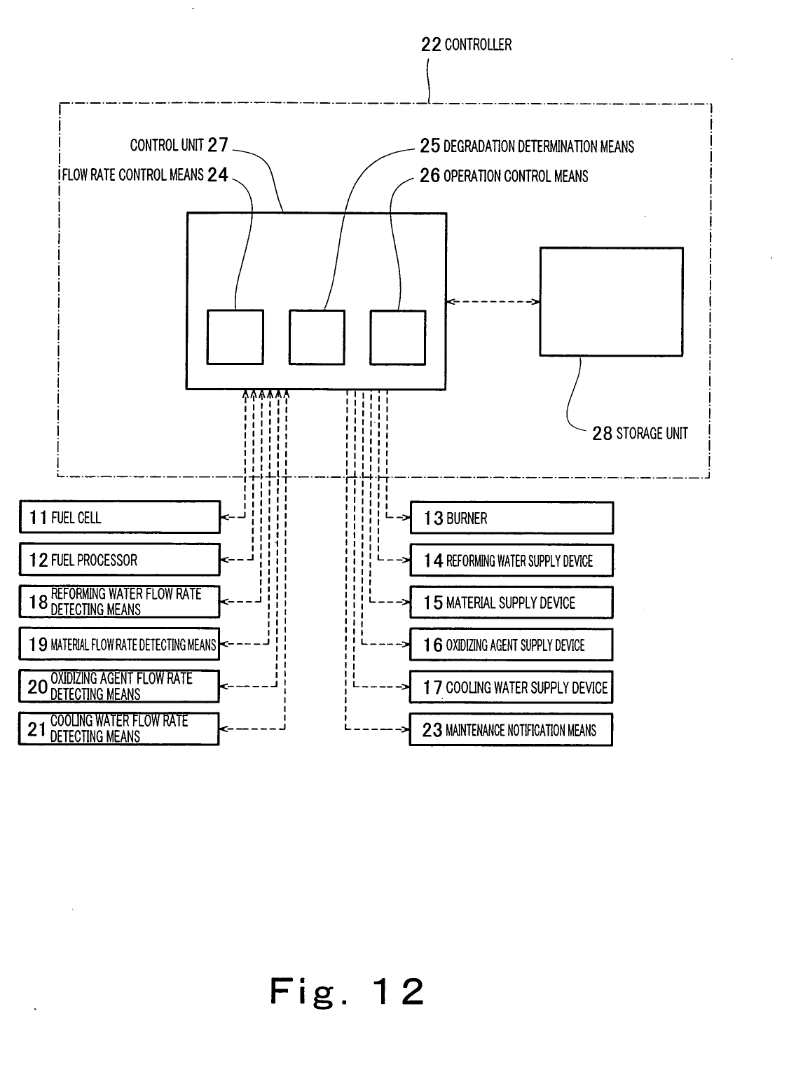

FIG. 11 is a block diagram schematically showing a construction of a fuel cell power generation system according to this embodiment. FIG. 12 is a block diagram schematically showing a configuration of a controller in the fuel cell power generation system according to this embodiment. Below, this embodiment will be described with reference to FIGS. 11 and 12. In FIGS. 11 and 12, the same reference numbers as those of FIGS. 1 and 2 designate corresponding components. In this embodiment, the economic efficiency determination means and the communication means are omitted from the components of the first embodiment. Since other components are identical to those of the first embodiment, they will be designated by the same reference numbers and will not be further described.

The operation of the fuel cell power generation system having the above construction is identical to that of the first embodiment, except for the process for determining whether or not the first degradation and the second degradation have occurred in the objects subjected to degradation determination, and therefore will not be further described.

A distinction between the first embodiment and second embodiment will be described. By way of example, in description below, a case where degradation has occurred in the cooling water supply device 17 will be described. As a matter of course, similar operation may take place for the case of the reforming water supply device 14, the material supply device 15, and the oxidizing gas supply device 16.

First, an operation for achieving the flow rate control of the fluid in the normal state will be described. Below, by way of example, control of the flow rate of the cooling water (hereinafter referred to as cooling water flow rate) will be described, and the flow rates of other fluids are controlled in a similar manner.

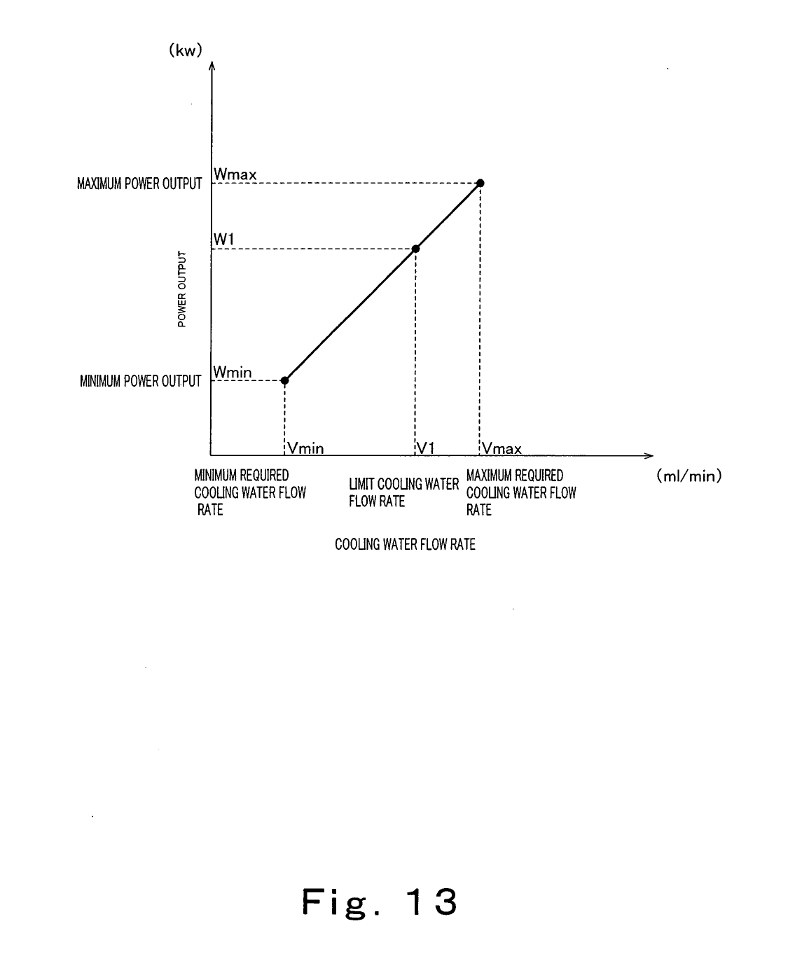

FIG. 13 is a conceptual diagram showing the relationship between the power output and a required flow rate of the cooling water (hereinafter referred to as required cooling water flow rate). Whereas the relationship between the power output and the required cooling water flow rate is indicated by a straight line as described below, it may alternatively be indicated by a curve, etc. As shown in FIG. 13, the required cooling water flow rate changes as the power output changes. The operation control means 26 calculates a control target value of the cooling water flow rate that meets a demanded power output with reference to the relationship and gives the control target value to the flow rate control means 24.

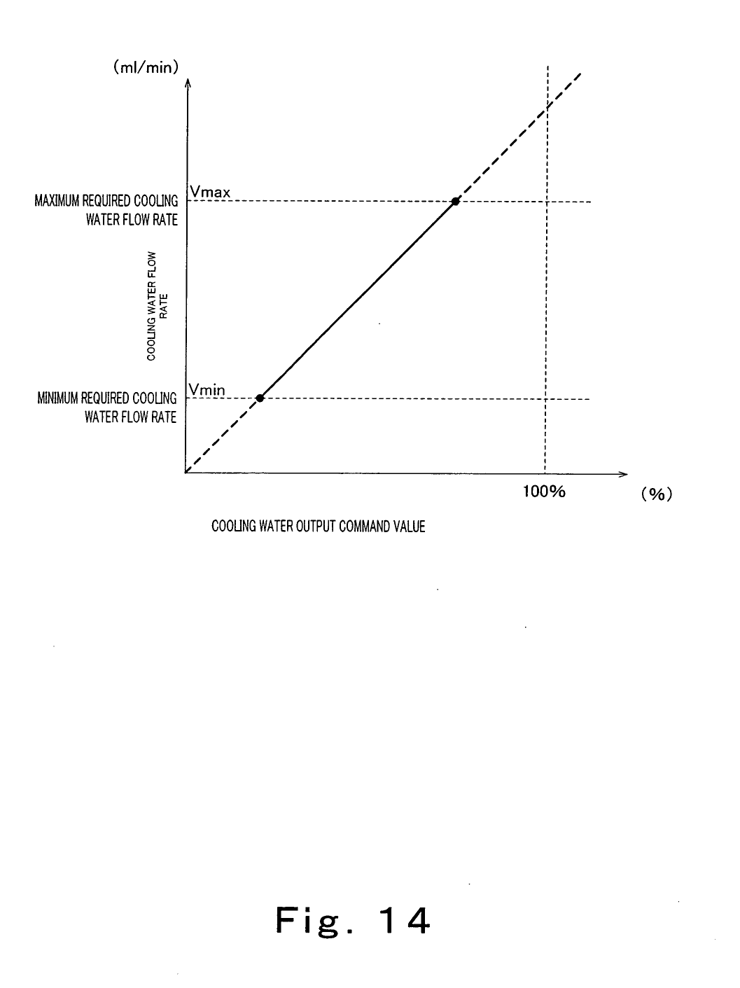

FIG. 14 is a conceptual diagram showing the relationship between the output command value (hereinafter referred to as cooling water output command value) given to the cooling water supply device 17 and the cooling water flow rate. Whereas the relationship between the cooling water output command value and the cooling water flow rate is described as indicated by a straight line, it may alternatively be indicated by a curve, etc. As shown in FIG. 14, the cooling water flow rate changes as the cooling water output command value changes. By utilizing this relationship, the flow rate control means 24 controls the cooling water flow rate to achieve a control target value of the required cooling water flow rate. In this embodiment, the flow rate control of the cooling water is executed by feedback control. To be specific, the flow rate control means 24 monitors a detection value (hereinafter referred to as detection value of the cooling water flow rate) which is sent from the cooling water flow rate detecting means 21 and controls the cooling water output command value until the control target value is achieved. It should be noted that the flow rate control of the cooling water may be executed by feedforward control if the cooling water supply device 17 outputs the cooling water in a specified amount with high precision in response to a specified cooling water output command value. In this case, the cooling water flow rate detecting means 21 is irrelevant to the control of the cooling water flow rate in a normal state. The feedforward control may be executed in the normal state, and the feedback control may be executed only when it is determined that degradation has occurred in the cooling water supply device 17.

As shown in FIG. 13, the power output which is capable of being supplied from the fuel cell power generation system ranges from a minimum value (hereinafter referred to as minimum power output) Wmin to a maximum value (hereinafter referred to as maximum power output) Wmax. Correspondingly, the required cooling water flow rate ranges from a minimum value (hereinafter referred to as minimum required cooling water flow rate) Vmin to a maximum value (hereinafter referred to as maximum required cooling water flow rate) Vmax. In contrast, the output command value given to the cooling water supply device 17 is limited in magnitude. Even if the output command value that exceeds an upper limit is given to the cooling water supply device 17, its flow rate does not change, or breakdown may occur in the cooling water supply device 17 because of an excessive load. For this reason, in a case where the required cooling water flow rate is large, the control target value of the cooling water flow rate cannot in some cases be achieved even if the output command value is increased up to the upper limit. However, as shown in FIG. 14, the system is configured so that the cooling water flow rate becomes equal to the maximum required reforming water flow rate Vmax without increasing the output command value up to the upper limit during the normal operation.

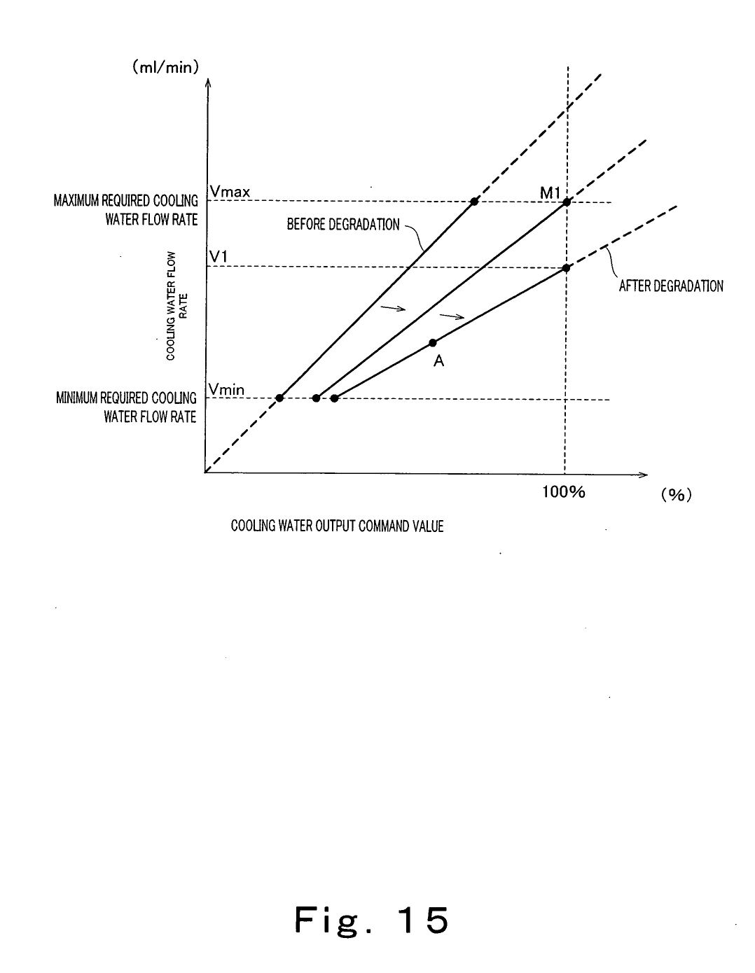

After a long time use of the cooling water supply device 17, degradation, for example, leakage in the passage or clogging in a filter attached to an inlet tends to occur. FIG. 15 is a conceptual diagram showing the relationship between the cooling water output command value and the cooling water flow rate in a case where such degradation has occurred. As shown in FIG. 15, with progress of degradation, a line indicating the relationship between the cooling water output command value and the cooling water flow rate shifts, and the cooling water flow rate increases up to but does not exceed V1 and does not become equal to the maximum required cooling water flow rate Vmax even if the cooling water output command value is increased up to the upper limit. Hereinbelow, the upper limit of an achievable cooling water flow rate is referred to as a limit cooling water flow rate. As shown in FIG. 13, when the cooling water flow rate increases up to but does not exceed the limit cooling water flow rate V1, the power output increases up to but does not exceed W1, and is thus unable to achieve the maximum power output Wmax. Under this condition, if an attempt is made to increase the power output beyond W1, deficiency of the cooling water flow rate occurs, causing breakdown to occur in the fuel cell 11 because of excess heat.

Thus far, the flow rate control of the cooling water has been described. Similarly, there is a correlation between the flow rate and the power output in the material, the reforming water, and the oxidizing agent, and the required flow rate changes according to the power output. Also, if the maximum value of the required flow rate cannot be achieved because of degradation of the respective supply devices, then the maximum power output Wmax cannot be achieved. Under this condition, if an attempt is made to increase the power output to more than the power output corresponding to the upper limit of the flow rate capable of being supplied, deficiency of the flow rate occurs, leading to problems that the interior of the fuel processor 12 is filled with excess water or soot originating from an excess material is deposited in the passage and clogs the passage.

A characteristic configuration of the fuel cell power generation system of this embodiment will now be described. In this characteristic configuration, it is assumed that the reforming water supply device 14, the material supply device 15, the oxidizing agent supply device 16, and the cooling water supply device 17 are the objects subjected to degradation determination. The degradation determination means 25 determines whether or not degradation (first degradation) that causes a need for maintenance because of economic efficiency or safety has occurred in each object subjected to degradation determination, based on the output command value given by the flow rate control means 24 and the corresponding detection value from the fluid flow rate detecting means. If it is determined that the first degradation has occurred, then the operation control means 26 imposes a limitation on the operation and causes the operation of the fuel cell power generation system to continue in an allowable range (limited operation). Simultaneously, the maintenance notification means 23 notifies the manager that the maintenance is needed.

As the degradation of the object subjected to degradation determination progresses and the limitation on the operation increases, power generation efficiency or safety in the whole system degrades. For this reason, the degradation determination means 25 determines whether or not degradation (second degradation) which causes a need to stop the operation because the required operation state cannot be maintained because of economic efficiency or safety has occurred in each object subjected to degradation determination, based on the output command value sent from the flow rate control means 24 and the corresponding detection value from the flow rate detecting means. If it is determined that the second degradation has occurred in the object subjected to degradation determination, the operation control means 26 causes the fuel cell power generation system to stop the operation.

Below, these operations will be described in detail. Below, the operation performed when degradation has occurred in the cooling water supply device 17 will be described. As a matter of course, similar operation may take place for the case of the reforming water supply device 14, the material supply device 15, and the oxidizing agent supply device 16.

First, a method of determining whether or not the first degradation has occurred in the reforming water supply device 17 will be described. In this embodiment, the degradation determination means 25 determines that the first degradation has occurred in the cooling water supply device 17, if the cooling water flow rate detected by the cooling water flow rate detecting means 21 does not reach the maximum required cooling water flow rate Vmax regardless of the control to set the cooling water output command value to not more than the upper limit.

In this embodiment, the degradation determination means 25 determines whether or not the first degradation has occurred in the cooling water supply device 17, when the control target value of the power output is set to the maximum power output Wmax. First, the maximum power output Wmax is set as the control target value. This setting is made, for example, in such a manner that the control unit 27 causes the storage unit 28 to store the maximum power output Wmax as the control target value. Thereby, the flow rate control means 24 controls the cooling water supply device 17 so that the cooling water flow rate becomes equal to the maximum required cooling water flow rate Vmax. The degradation determination means 25 monitors the cooling water output command value and the detection value of the cooling water flow rate. If the detection value of the cooling water flow rate indicates that the cooling water flow rate does not reach the maximum required cooling water flow rate Vmax regardless of the control of the cooling water output command value, the degradation determination means 25 determines that the first degradation has occurred in the cooling water supply device 17.

If it is determined that the first degradation has occurred in the cooling water supply device 17, this is communicated to the operation control means 26 and the maintenance notification means 23. The operation control means 26 sets that the power output W1 (FIG. 13) corresponding to the limit cooling water flow rate V1 as the upper limit of the power output (hereinafter referred to as the limit power output) and causes the fuel cell power generation system to continue the operation (limited operation) with a power output that does not exceed the limit power output. The maintenance notification means 23 notifies the manager that the maintenance is needed.

By the above mentioned operation, the fuel cell power generation system of this embodiment is able to continue the operation in an allowable range and to notify the manager that maintenance is needed, under the condition in which the first degradation has occurred in the cooling water supply device 17.

Whereas in this embodiment, the operation can be continued by setting the upper limit of the power output when it is determined that the first degradation has occurred in the cooling water supply device 17, other conditions may alternatively be set. Any conditions may be set so long as the operation can continue in an allowable range depending on the degree of degradation that has occurred in the cooling water supply device 17.

In this embodiment, the degradation determination means 25 determines that the first degradation has occurred in the cooling water supply device 17, when the cooling water flow rate does not reach the maximum required cooling water flow rate Vmax regardless of the control to set the cooling water output command value to not more than the upper limit. Any determination method may be employed to determine whether or not the first degradation has occurred in the cooling water supply device 17 so long as it is determined that maintenance of the cooling water supply device 17 is needed based on the cooling water output command value and the detection value of the cooling water flow rate. For example, it may be determined that the first degradation has occurred when the maximum required cooling water flow rate Vmax is achieved in response to a given specified output command value (e.g., 80% of the upper limit) below the upper limit. In this case, the problem does not substantially arise if the operation is performed with the maximum power output Wmax. Therefore, without limiting the operation, the manager is notified that maintenance is needed. This makes it possible to notify the manager that maintenance is needed in an initial stage of degradation where limitation on the operation is unnecessary. As a result, the manager is able to safely carry out maintenance such as change or repair of components.

After it is determined that the first degradation has occurred in the cooling water supply device 17, the degradation of the cooling water supply device 17 may progress unless maintenance is carried out. As the degradation progresses, the limit cooling water flow rate V1 decreases. In this embodiment, using the cooling water flow rate detecting means 21, it is determined whether or not the cooling water flow rate reaches V1 each time the limit cooling water flow rate V1 is set to the control target value, and sets the cooling water flow rate at that point of time as the limit cooling water flow rate V1, if V1 is not reached. The operation is continued with the power output corresponding to the updated V1 set as the limit power output. Thereby, the allowable range of the operation can be changed suitably according to the progress of the degradation, and power generation can be carried out stably.

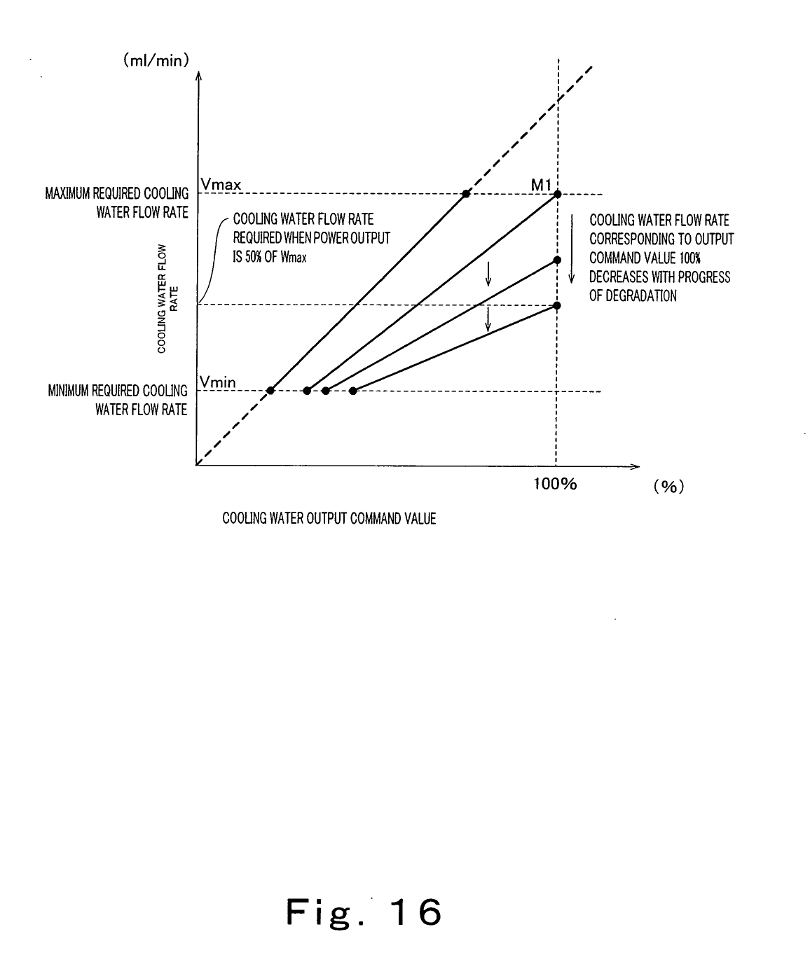

Subsequently, a method of determining whether or not second degradation has occurred in the cooling water supply device 17 will be described. As shown in FIG. 16, the degradation progresses unless maintenance is carried out. In this embodiment, it is determined that the second degradation has occurred in the cooling water supply device 17 if the cooling water flow rate detected by the cooling water flow rate detecting means 21 does not reach the flow rate required to achieve 50% of the maximum power output Wmax, regardless of the control to set the cooling water output command value to not more than the upper limit.

In this embodiment, it is determined whether or not the second degradation has occurred in the cooling water supply device 17 when the control target value of the power output approaches 50% of the maximum power output Wmax. When the control target value of the power output approaches 50% of the maximum power output Wmax, this is communicated to the flow rate control means 24 and the degradation determination means 25. The flow rate control means 24 controls the cooling water supply device 17 so that the cooling water flow rate becomes equal to the required cooling water flow rate corresponding to the control target value of the power output. The degradation determination means 25 monitors the cooling water output command value and the detection value of the cooling water flow rate. If the detection value of the cooling water flow rate indicates that the cooling water flow rate does not reach the required cooling water flow rate corresponding to 50% of the maximum power output Wmax, although the cooling water output command value is equal to the upper limit, the degradation determination means 25 determines that the second degradation has occurred in the cooling water supply device 17. If it is determined that the second degradation has occurred in the cooling water supply device 17, this is communicated to the operation control means 26. The operation control means 26 then causes the fuel cell power generation system to stop the operation.

By the above mentioned operation, the fuel cell power generation system of this embodiment is able to stop the operation of the fuel cell power generation system when degradation has occurred in the cooling water supply device 17 and the required operation state cannot be maintained because of economic efficiency and safety. Thereby, it is possible to inhibit continuation of the operation under the condition in which the economic efficiency and safety have some problems when the degradation has occurred in the cooling water supply device 17.

In this embodiment, it is determined that the second degradation has occurred in the cooling water supply device 17, when the cooling water flow rate does not reach the cooling water flow rate corresponding to 50% of the maximum power output Wmax, regardless of the control to set the cooling water output command value to not more than the upper limit. Any determination method may be employed to determine whether or not the second degradation has occurred in the cooling water supply device 17 so long as it is determined whether or not a required operation state can be maintained considering economic efficiency and safety based on the cooling water output command value and the detection value of the cooling water flow rate. For example, the degradation determination means 25 may determine that the second degradation has occurred in the cooling water supply device 17 when the cooling water flow rate does not reach the cooling water flow rate corresponding to 50% of the maximum power output Wmax in response to a given specified output command value (e.g., 80% of the upper limit) below the upper limit.

Whereas in this embodiment, the flow meter is used as the cooling water flow rate detecting means 21, a pressure meter that detects a pressure of the cooling water or a velocity meter that detects a velocity of the cooling water may alternatively be equipped to determine whether or not it is necessary to carry out the maintenance of the cooling water supply device 17 or whether or not it is necessary to stop the operation based on the relationship between the output command value and the pressure or the velocity. Thereby, it is possible to continue the operation thereof in an allowable range and to notify the manager that maintenance of the cooling water supply device 17 is needed, even when the flow rate is not directly detected. In addition, it is possible to stop the operation if the degradation of the cooling water supply device 17 progresses and thus the required operation state cannot be maintained because of economic efficiency and safety.

When degradation has occurred in the fluid supply devices other than the cooling water supply device 17, for example, the material supply device 15, the reforming water supply device 14, and the oxidizing agent supply device 16, similar effects are obtained by similar operations. As a result, against a situation where degradation has occurred in any of the fluid supply devices, it is possible to continue the operation in an allowable range and to notify the manager that maintenance of the fluid supply device is needed. In addition, it is possible to stop the operation if the degradation of that fluid supply device progresses and thus the required operation state cannot be maintained because of economic efficiency and safety.

To determine whether or not degradation has occurred in plural fluid supply devices, it is desirable that the maintenance notification means 23 have notification patterns differed for the respective fluid supply devices. This enables the manager to easily recognize time and objects of maintenance and thus to carry out maintenance of the fuel cell power generation system more efficiently.

If it is determined that the first degradation has occurred in the plural fluid supply devices in a case where it is determined whether or not the degradation has occurred in the plural fluid supply devices, it is desired that the fuel cell power generation system be operated with a power output which does not exceed a limit power output which is the lowest power output among power outputs corresponding to flow rates responsive to upper limit output command values given to the respective fluid supply devices. As a result, against a situation where degradation has occurred in the plural fluid supply devices, it is possible to continue the operation in an allowable range and to notify the manager that maintenance of the associated fluid supply devices is needed.

If it is determined that the second degradation has occurred in any one of the fluid supply devices in a case where it is determined whether or not the degradation has occurred in the plural fluid supply devices, it is desirable to stop the operation. As a result, the operation can be stopped in a case where maintenance is not carried out and the required operation state cannot be maintained because of economic efficiency and safety due to degradation of any one of the fluid supply devices.

### EMBODIMENT 3

In the second embodiment of the present invention, the degradation determination means 25 determines that the first degradation and the second degradation have occurred in the objects subjected to degradation determination if the required flow rate according to the control target value of the power output is unachievable in a case where the control is actually executed to achieve the required flow rate. In contrast, in a third embodiment of the present invention, the output command value and the detection value of the fluid are stored, the flow rate in the case where the output command value is set to the upper limit is predicted using the stored result, and the degradation determination means 25 determines whether or not the first degradation and the second degradation have occurred in the objects subjected to degradation determination based on the predicted result. In the third embodiment, in addition, in a case where it is determined that first degradation has occurred in the objects subjected to degradation determination, the manager located in a remote place is notified that maintenance is needed through communication means.

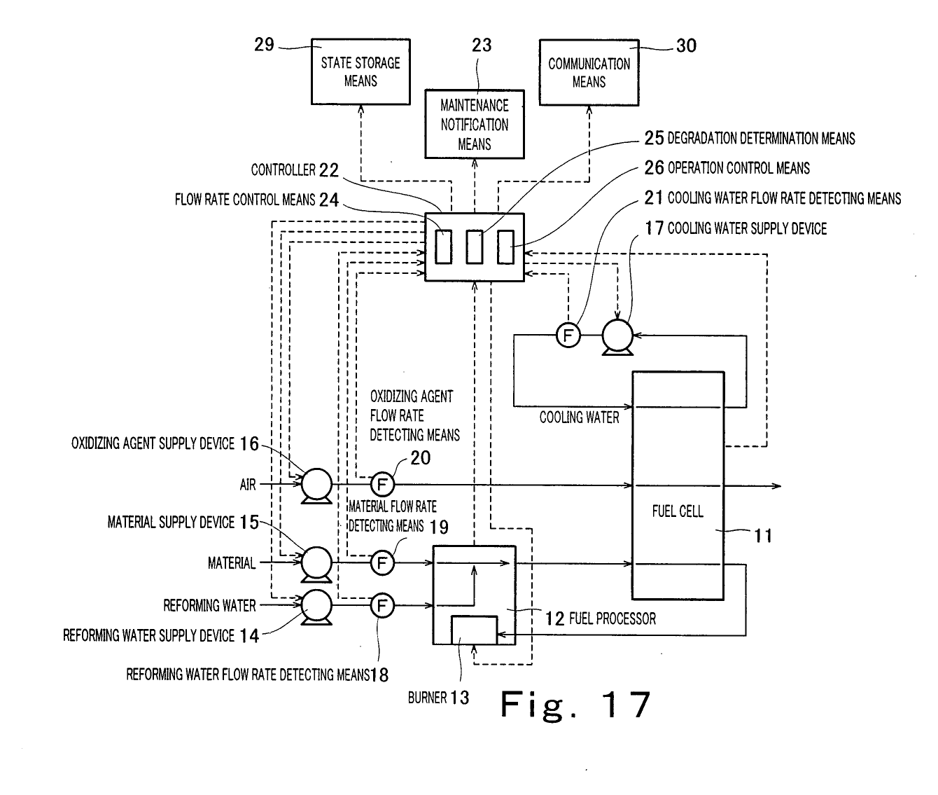

FIG. 17 is a block diagram schematically showing a construction of a fuel cell power generation system according to this embodiment. Hereinbelow, this embodiment will be described with reference to FIG. 17. In FIG. 17, the same reference numerals as those of FIG. 11 designate the same or corresponding components. In this embodiment, state storage means 29 and communication means 30 are added to the construction of the second embodiment, and the other components are identical to those of the second embodiment. Therefore, the corresponding components in this embodiment and in the second embodiment (components referenced to by the same reference numbers in FIGS. 11 and 17) will not be further described.

The state storage means 29 is a state storage means that stores the output command values which are sent from the controller 22 to the material supply device 15, the reforming water supply device 14, the oxidizing agent supply device 16, and the cooling water supply device 17 and the detection values of the flow rates which are input to the controller 22 from the reforming water flow rate detecting means 18, the material flow rate detecting means 19, the oxidizing agent flow rate detecting means 20, and the cooling water flow rate detecting means 21. As the state storage means 29, for example, an external memory is used. The communication means 30 serves as a communication means (including transmission and reception) to notify the manager that maintenance of the fuel cell power generation system is needed. As the communication means 30, for example, a terminal coupled to communication networks such as a radio, a telephone line, or Internet, is used.

The operation other than the method of determining whether or not the first degradation and the second degradation have occurred in the objects subjected to degradation determination and the method of notifying the manager that maintenance is needed is identical to that of the second embodiment, and therefore will not be further described.

A distinction between the third embodiment and the second embodiment will be described below. Below, by way of example, a case where degradation has occurred in the cooling water supply device 17 will be described. As a matter of course, similar operation may take place for the case of the reforming water supply device 14, the material supply device 15, and the oxidizing agent supply device 16.

In this embodiment, the degradation determination means 25 determines that the first degradation has occurred in the cooling water supply device 17, if the cooling water flow rate detected by the cooling water flow rate detecting means 21 does not reach the maximum required cooling water flow rate Vmax regardless of the control to set the cooling water output command value to not more than the upper limit. In addition, in this embodiment, the degradation determination means 25 determines that the second degradation has occurred in the cooling water supply device 17, if the cooling water flow rate detected by the cooling water flow rate detecting means 21 does not reach the flow rate required to achieve 50% of the maximum power output Wmax, regardless of the control to set the cooling water output command value to not more than the upper limit. In order to determine whether or not the first degradation and the second degradation have occurred in the cooling water supply device 17, in this embodiment, a limit cooling water flow rate V1 is predicted.

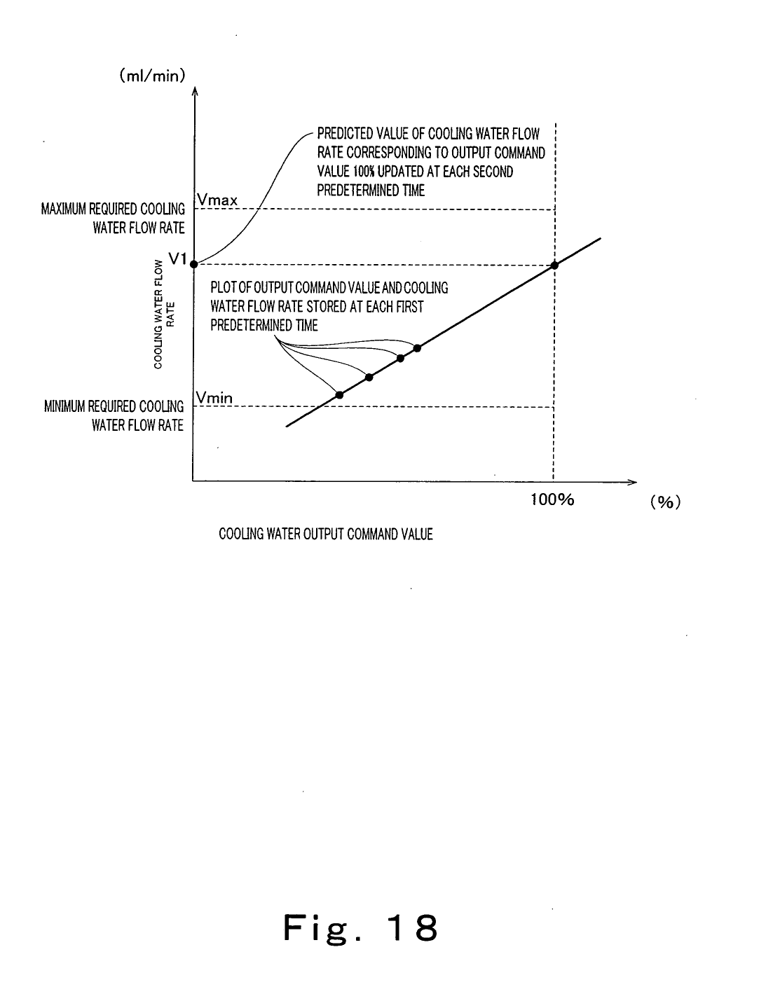

First, the method of determining whether or not the first degradation has occurred in the cooling water supply device 17 will be described. FIG. 18 is a conceptual diagram showing a method of predicting the limit cooling water flow rate V1 in this embodiment. Whereas the relationship between the cooling water output command value and the cooling water flow rate is indicated by a straight line as described below, it may alternatively be indicated by a curve, etc. The cooling water output command value and the detection value of the cooling water are stored in the state storage means 29 at each first predetermined time. This storage is updated at each second predetermined time. The degradation determination means 25 predicts the limit cooling water flow rate V1 at each time that is longer than the first predetermined time and is not longer than the second predetermined time, based on the relationship between the cooling water output command value and the cooling water flow rate and the cooling water output command value and the detection value of the cooling water flow rate which are stored in the state storage means 29. The first predetermined time may be, for example, one minute, five minutes, ten minutes, or one hour. The second predetermined time may be one hour, one day, or one week. The predicting method may employ, for example, prediction by linear regression. If the predicted limit cooling water flow rate V1 is lower than the maximum required cooling water flow rate Vmax, the degradation determination means 25 determines that the first degradation has occurred in the cooling water supply device 17.

When it is determined that the first degradation has occurred in the cooling water supply device 17, this is communicated to the operation control means 26, the maintenance notification means 23, and the communication means 30. The operation control means 26 sets the power output W1 (FIG. 13) corresponding to the predicted limit cooling water flow rate V1 as the limit power output and causes the fuel cell power generation system to continue the operation (limited operation) with a power output that does not exceed the limit power output. The maintenance notification means 23 notifies the manager that maintenance is needed. Furthermore, the communication means 30 informs the manager located in a remote place that maintenance is needed.

By the above mentioned operation, the fuel cell power generation system of this embodiment is able to determine that maintenance of the cooling water supply device 17 is needed before the required cooling water flow rate actually becomes unachievable. Thereby, the manager is notified in an earlier stage that maintenance is needed. Furthermore, the manager located in the remote place is able to be informed that maintenance is needed. As a result, efficient and safe management and maintenance become possible.

As in the second embodiment, in this embodiment, a condition different from setting the upper limit in the power output may be set. Any determination method may be employed to determine whether or not the first degradation has occurred in the cooling water supply device 17 so long as it is determined that maintenance of the cooling water supply device 17 is needed in a stage before the required cooling water flow rate actually becomes unachievable, based on the cooling water output command value and the detection value of the cooling water flow rate. For example, the degradation determination means 25 may determine that the first degradation has occurred in a case where it is predicted that the maximum required cooling water flow rate Vmax will be achievable by giving a specified output command value (e.g., 80% of the upper limit) below the upper limit. In this case, the problem does not substantially arise if the operation is performed with the maximum power output Wmax. Therefore, without limiting the operation, the manager is notified that maintenance is needed. This makes it possible to notify the manager that maintenance is needed in an initial stage of degradation where limitation on the operation is unnecessary. As a result, the manager is able to safely carry out maintenance such as change or repair of components.

After it is determined that the first degradation has occurred in the cooling water supply device 17, the degradation of the cooling water supply device 17 may progress unless maintenance is carried out. As the degradation progresses, the limit cooling water flow rate V1 decreases. In this embodiment, the limit cooling water flow rate V1 is re-predicted and the power output corresponding to V1 is re-calculated at each second predetermined time. If the power output is lower than the limit power output, then the value of the limit power output is updated to that power output. Thereby, the allowable range of the operation can be suitably changed according to the progress of degradation and power generation can be carried out stably.

Subsequently, the method of determining whether or not the second degradation has occurred in the cooling water supply device 17 will be described. The degradation may progress unless maintenance is carried out. In this embodiment, it is determined that the second degradation has occurred in the cooling water supply device 17 if the limit cooling water flow rate V1 does not reach the flow rate required to achieve 50% of the maximum power output Wmax. In this embodiment, the degradation determination means 25 predicts the limit cooling water flow rate V1 at each second predetermined time, and determines that the second degradation has occurred in the cooling water supply device 17 if the predicted limit cooling water flow rate V1 is less than the required flow rate corresponding to 50% of the maximum power output Wmax. If it is determined that the second degradation has occurred in the cooling water supply device 17, this is communicated to the operation control means 26, which causes the fuel cell power generation system to stop the operation.

By the above mentioned operation, the fuel cell power generation system of this embodiment is able to determine whether or not the required operation state can be maintained considering economic efficiency and safety before the required cooling water flow rate actually becomes unachievable. Thereby, it is possible to determine whether or not the degradation has occurred in the cooling water supply device 17 in an earlier stage and to inhibit continuation of the operation under the condition in which the economic efficiency and safety have some problems.

In this embodiment, it is determined that the second degradation has occurred in the cooling water supply device 17, when the predicted limit cooling water flow rate V1 is less than the required cooling water flow rate corresponding to 50% of the maximum power output Wmax. Alternatively, it may be determined that the second degradation has occurred in the cooling water supply device 17 if, for example, the predicted limit cooling water flow rate V1 is less than the required cooling water flow rate corresponding to the power output with a percentage other than 50% (e.g., 60%) of the maximum power output Wmax. Any determination method may be employed to determine whether or not the second degradation has occurred in the cooling water supply device 17 so long as it is determined based on the cooling water output command value and the detection value of the cooling water flow rate whether or not a required operation state can be maintained considering economic efficiency and safety in a stage before the required cooling water flow rate actually becomes unachievable.

In this embodiment, also, instead of the flow meter, the cooling water flow rate detecting means 21 may be a pressure meter that detects a pressure of the cooling water or a velocity meter that detects a velocity of the cooling water to determine whether or not it is necessary to carry out the maintenance of the cooling water supply device 17 or whether or not it is necessary to stop the operation based on the relationship between the output command value and the pressure or the velocity. When degradation has occurred in the fluid supply devices other than the cooling water supply device 17, for example, the material supply device 15, the reforming water supply device 14, and the oxidizing agent supply device 16, similar effects are obtained by similar operations. To determine whether or not degradation has occurred in plural fluid supply devices, it is desirable that the maintenance notification means 23 have notification patterns differed for the respective fluid supply devices. If it is determined that the first degradation has occurred in the plural fluid supply devices in a case where it is determined whether or not the degradation has occurred in the plural fluid supply devices, it is desired that the fuel cell power generation system be operated with a power output which does not exceed an upper limit which is the lowest power output among possible maximum power outputs corresponding to the respective fluids. In addition, it is desirable to stop the operation if it is determined that the second degradation has occurred in any one of the plural supply devices in the case where it is determined whether or not degradation has occurred in the plural supply devices.

### EMBODIMENT 4

In the third embodiment, the flow rate in the case where the output command value is set to the upper limit is predicted based on the output command value and the detection value of the flow rate, and the degradation determination means 25 determines whether or not the first degradation and the second degradation have occurred in the object subjected to degradation determination based on the predicted result. In contrast, in a fourth embodiment, without predicting the flow rate, the degradation determination means 25 determines whether or not the first degradation and the second degradation have occurred in the object subjected to degradation determination with reference to the relationship between the output command value and the detection value of the fluid flow rate in a state where the degradation has not occurred yet.

Since the construction of the fuel cell power generation system of this embodiment is identical to that of the third embodiment, it will not be further described. In addition, since the operation of the fuel cell power generation system of this embodiment other than the method of determining whether or not the first degradation and the second degradation have occurred in the objects subjected to degradation determination is identical to that of the third embodiment, it will not be further described.

A distinction between the third embodiment and fourth embodiment will be described. By way of example, in description below, a case where degradation has occurred in the cooling water supply device 17 will be described. As a matter of course, similar operation may take place for the case of the reforming water supply device 14, the material supply device 15, and the oxidizing agent supply device 16.

The degradation determination means 25 determines that the first degradation has occurred in the cooling water supply device 17, if the cooling water flow rate detected by the cooling water flow rate detecting means 21 does not reach the maximum required cooling water flow rate Vmax, regardless of the control to set the cooling water output command value to not more than the upper limit.

In addition, the degradation determination means 25 determines that the second degradation has occurred in the cooling water supply device 17 if the cooling water flow rate detected by the cooling water flow rate detecting means 21 does not reach the flow rate required to achieve 50% of the maximum power output Wmax, regardless of the control to set the cooling water output command value to not more than the upper limit value. In this embodiment, in order to determine whether or not the first degradation and the second degradation have occurred in the cooling water supply device 17, the relationship between the cooling water output command value and the cooling water flow rate in the state where the first degradation and the second degradation have not occurred yet in the cooling water supply device 17 is used.

First, the method of determining whether or not the first degradation has occurred in the cooling water flow supply device 17 will be described. In this embodiment, at the completion of the fuel cell power generation system or at the termination of maintenance of the cooling water supply device 17 (hereinafter referred to as at initial operation), the cooling water output command value is increased up to the upper limit at constant intervals, and the associated cooling water output command values and the associated detection values of the cooling water flow rate are stored in the state storage means 29. Based on the cooling water output command values and the detection values of the cooling water flow rate which are stored, a line indicating the relationship between the cooling water output command value and the cooling water flow rate in the state where the degradation has not occurred yet in the cooling water supply device 17 is decided. This line is hereinafter referred to as an initial value line. A method of deciding the initial value line is not intended to be limited to that increases the output command value at the constant intervals as described above, but various method may be employed, for example, a method of storing the cooling water output command value and the detection value of the cooling water flow rate at constant time intervals. Any deciding method may be employed to decide the initial value line so long as it is based on the cooling water output command value and the detection value of the cooling water flow rate at the initial operation.

In addition, a first threshold line indicating the relationship between the output command value and the flow rate in the state where degradation has progressed to an extent that maintenance becomes needed and a second threshold line indicating the relationship between the output command value and the flow rate in the state where degradation has progressed to an extent that the required operation state cannot be maintained because of economic efficiency and safety are decided based on the initial value line. In this embodiment, the initial value line is parallel-shifted to pass through a point at which the maximum required cooling water flow rate Vmax and the upper limit of the output command value intersect each other, to create the first threshold line. Also, the initial value line is parallel-shifted to pass through a point at which the cooling water flow rate required when the power output is 50% of the maximum power output Wmax and the upper limit of the output command value intersect each other, to create the second threshold line. The parallel-shift is not necessarily employed to decide the respective threshold lines, but parameters of a straight line or a curve indicating the relationship between the output command value and the flow rate is calculated from the initial value line, and the respective threshold lines may be decided based on the parameters. Any deciding method may be employed to decide the threshold lines so long as it is based on the initial value line decided at the initial operation.

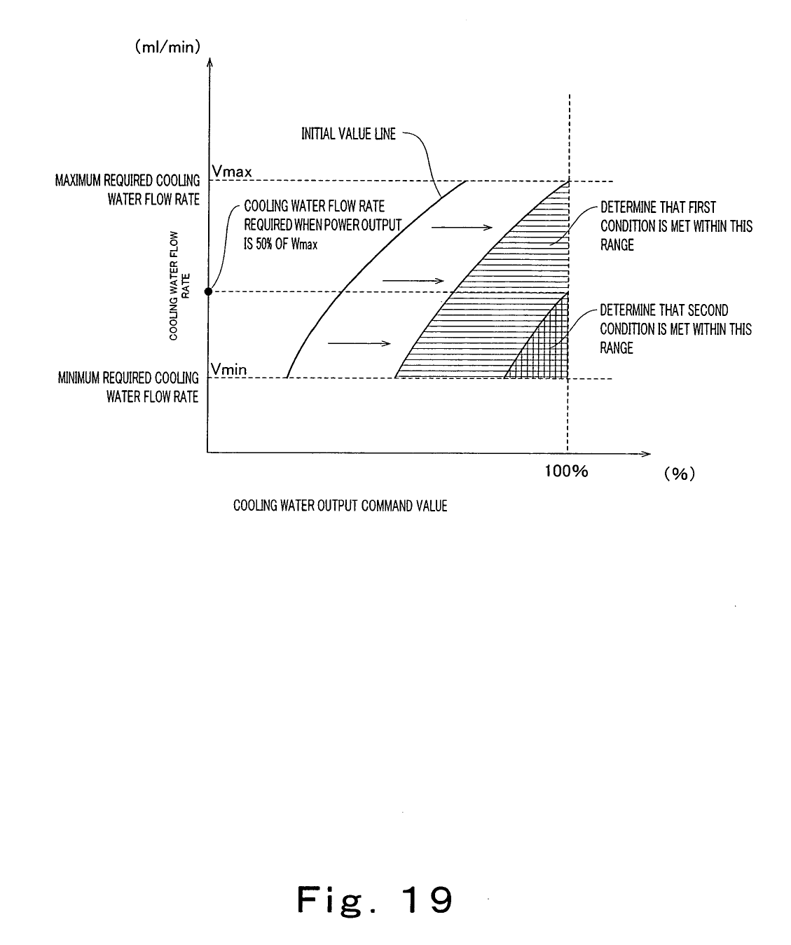

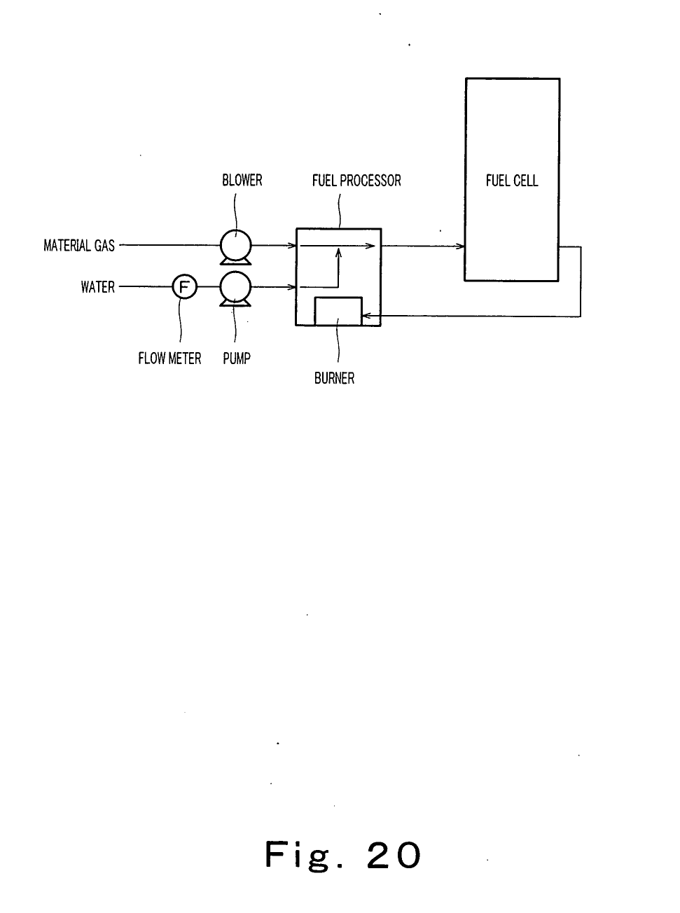

FIG. 19 is a conceptual diagram showing the degradation determination method of this embodiment. In this embodiment, the cooling water output command value and the cooling water flow rate obtained from the detection value of the cooling water flow rate are plotted on a cooling water output command value—cooling water flow rate plane, and the degradation determination means 25 determine that the first degradation has occurred in the cooling water supply device 17 if the plot is below the first threshold line.

When it is determined that the first degradation has occurred in the cooling water supply device 17, this is communicated to the operation control means 26, the maintenance notification means 23, and the communication means 30. The operation control means 26 sets 50% of the maximum power output Wmax as the limit power output and causes the fuel cell power generation system to continue the operation with a power output that does not exceed the limit power output (limited operation). The maintenance notification means 23 notifies the manager that maintenance is needed. Furthermore, the communication means 30 informs the manager located in the remote place that maintenance is needed.

By the above mentioned operation, the fuel cell power generation system of this embodiment is able to determine that maintenance of the object subjected to degradation determination is needed in the stage before the required flow rate becomes unachievable without predicting the limit cooling water flow rate V1. Thereby, it can be determined whether or not the first degradation has occurred in the cooling water supply device 17 in the earlier stage and with a simple method, and maintenance such as change or repair of the components can be carried out. Further, the manager located in the remote place can be informed that maintenance of the fuel cell power generation system is needed. As a result, more efficient management and maintenance become possible.

Subsequently, a method of determining whether or not the second degradation has occurred in the cooling water supply device 17 will be described. In this embodiment, when the plot is below the second threshold line, the degradation determination means 25 determines that the second degradation has occurred in the cooling water supply device 17. When it is determined that the second degradation has occurred in the cooling water supply device 17, this is communicated to the operation control means 26, which causes the fuel cell power generation system to stop the operation.

By the above mentioned operation, the fuel cell power generation system of this embodiment is able to determine that the required operation state cannot be maintained because of economic efficiency and safety before the required cooling water flow rate actually becomes unachievable without predicting the limit cooling water flow rate V1. Thereby, it is possible to determine whether or not the degradation has occurred in the cooling water supply device 17 in the earlier stage and with the simple method, and to inhibit continuation of the operation in a state in which the economic efficiency and the safety have some problems.

As in the second embodiment, in this embodiment, a condition different from setting the upper limit in the power output may be set. Any determination method may be employed to determine whether or not the first degradation has occurred in the cooling water supply device 17 so long as it is determined that maintenance of the cooling water supply device 17 is needed, based on the cooling water output command value and the detection value of the cooling water flow rate. Any determination method may be employed to determine whether or not the second degradation has occurred in the cooling water supply device 17 so long as it is determined that the required operation state cannot be maintained because of economic efficiency and safety, based on the cooling water output command value and the detection value of the cooling water flow rate.

Instead of the flow meter, the cooling water flow rate detecting means 21 may be a pressure meter that detects a pressure of the cooling water or a velocity meter that detects a velocity of the cooling water to determine whether or not it is necessary to carry out the maintenance of the cooling water supply device 17 or whether or not it is necessary to stop the operation based on the relationship between the output command value and the pressure or the velocity. When degradation has occurred in the fluid supply devices other than the cooling water supply device 17, for example, the material supply device 15, the reforming water supply device 14, and the oxidizing agent supply device 16, similar effects are obtained by similar operations. To determine whether or not degradation has occurred in plural fluid supply devices, it is desirable that the maintenance notification means 23 have notification patterns differed for the respective fluid supply devices. If it is determined that the degradation has occurred in the plural fluid supply devices in a case where it is determined whether or not the degradation has occurred in the plural fluid supply devices, it is desired that the fuel cell power generation system be operated with a power output which does not exceed an upper limit power output which is the lowest power output among possible maximum power outputs corresponding to the respective fluids. In addition, it is desirable to stop the operation if it is determined that the second degradation has occurred in any of the plural supply devices in the case where it is determined whether or not degradation has occurred in the plural supply devices.

### SUPPLEMENTAL EXPLANATION OF FIRST TO FOURTH EMBODIMENTS

The term “fluids” recited in claims and description means gasses and liquids for use in the fuel cell power generation system. By way of example, the fluids are the reforming water and the material which are supplied to the fuel processor, the fuel, the oxidizing agent, the cooling water, and the cooling air which are supplied to the fuel cell, the fuel and the air used to heat the fuel processor, the air and the cooling water which are supplied to the fuel processor, circulated water for heat recovery, etc.

The term “fluid supply devices” recited in claims and description refers to devices including means for supplying the fluids to specified locations, including inlets of the fluids, outlets of the fluids, flow rate control valves, passages, etc, as well as output units. By way of example, the fluid supply devices are a blower, a fan, a pump, or a needle valve, a proportional valve, a pipe, and a filter which are coupled to these, etc. Specific examples of the blower, the fan, and the pump are a plunger pump, a diaphragm pump, a centrifugal pump, a turbo blower, a scroll blower, a ring blower, a sirocco fan, etc.

The term “detection” recited in claims and description means obtaining a value or a signal having a relationship with a specified physical amount using sensors and so on, and includes not only obtaining a measurement value having a specified unit corresponding to the physical amount but detecting the physical amount as an electric signal (voltage, etc) and executing control without converting the electric signal into the physical amount.

The term “fluid flow rate detecting means” recited in claims and description refers to means for detecting the physical amounts such as the flow rate, the pressure and the velocity of the fluid, which have a relationship with the flow rate of the fluid. By way of example, the fluid flow rate detecting means are the flow meter, the pressure sensor, the velocity meter, etc.

The term “degradation” recited in claims and description means degradation of the fluid supply device's ability to supply the fluid, and includes not only degradation of the fluid supply device itself due to wear of the fan and so on but degradation of the ability to supply the fluid in a whole system due to clogging in the filter provided in the fluid passage or water leakage from, and clogging in, the fluid passage.

The terms “flow rate control means,” “degradation determination means” and “operation control means” recited in claims and description refer to any means that are configured to be able to control the flow rates of the associated fluids, determine whether or not the degradation has occurred in the fluid supply devices, and control the operation of the fuel cell power generation system. By way of example, they are a microcomputer board or an IC chip including electronic circuits, etc.

The number of the flow rate control means, the number of the degradation determination means, and the number of the operation control means are not specifically limited. For example, one flow rate control means, one degradation determination means, and one operation control means may be equipped so as to correspond to each of all the fluids. The flow rate control means, the degradation determination means, and the operation control means may be equipped in number so as to correspond to the kinds of the respective fluids. Furthermore, the flow rate control means, the degradation determination means, and the operation control means are not necessarily separately equipped to execute distributed control, but may be implemented by one controller (microcomputer, etc) to execute centralized control.

The term “maintenance” recited in claims and description refers to a procedure for restoring the fluid supply device's ability to supply fluid when the degradation has occurred in the fluid supply device. To be specific, the maintenance includes change of the pump, cleaning of the filter, repair of the piping, etc.

The term “notification” recited in claims and description means an operation to transmit information to a third party. Specifically, the notification includes transmission by sound or light, etc, and more specifically transmission by an alarm sound, characters, graphics, an alarm light, etc.

The term “maintenance notification means” recited in claims and description refers to means for notifying that maintenance of the fluid supply devices included in the fuel cell power generation system is needed. By way of example, the maintenance notification means are a buzzer or a speaker for emitting the alarm sound, a lamp or a light emitting diode which is the alarm light, a display for displaying characters or graphics, etc.

The term “output command values” recited in claims and description refers to command values for controlling the flow rates given to the fluid supply devices. The control of the flow rates may be executed by the feedback control or the feedforward control. To be specific, the output command values are, for example, the flow rate, the ratio (%, etc) to the maximum required flow rate, voltage, current, frequency (number of rotations), the ratio (%, etc) to the maximum frequency (number of rotations), opening degree of the flow rate control valve, etc, but may be other values which may be used to control the flow rate.

The term “allowable ranges” recited in claims and description means a range in which the fluid supply device and other components are not adversely affected, or efficiency and safety of the whole fuel cell power generation system are not adversely affected under the presence of degradation which has occurred in the fluid supply device. To be specific, the allowable ranges are the range of power output, the ranges of the flow rate, the pressure, etc of the respective fluids, temperature ranges at specified points in the fuel cell power generation system, etc.

The term “state storage means” recited in claims and description refers to means for storing parameters indicating the states of the fluid supply devices. To be specific, the state storage means are for example, a flash memory, a nonvolatile memory, hard disc, etc. The time, place, and so on of the “state” are not specifically limited. That is, they may be the time of shipping from factory, the time of component change, time of degradation, or place such as factory, store, or delivery destination, or average of lot or actual article installed in the fuel cell power generation system, etc.

The term “communication means” recited in claims and description refers to means for notifying the manager located in the remote place who is unable to be notified by the maintenance notification means that maintenance of the fluid supply devices included in the fuel cell power generation system is needed, and includes transmission and reception. To be specific, the communication means are, for example, transmitter and receiver, or terminals using telephone line, LAN, Internet, radio, etc as communication lines.

The term “initial operation” recited in claims and description refers to the operation carried out under the absence of degradation in the objects subjected to degradation determination after the fuel cell power generation system is completed or the maintenance is ended. In other words, “the initial operation” is not necessarily limited to the operation just after the maintenance, but may be the operation that is carried out under the absence of degradation in the objects subjected to degradation determination during a time period after the fuel cell power generation system is completed or the maintenance is ended. In addition, the initial operation is not necessarily limited to the operation of the whole fuel cell power generation system or the operation carried out after the maintenance, but may be the operation of only the objects subjected to degradation determination or the operation for confirming that the ability to supply the fluid is restored during the maintenance.

The term “maximum power output” recited in claims and description refers to a maximum power output in design with which the fuel cell power generation system is allowed to operate economically, and safely.

The term “first degradation” recited in claims and description refers to degradation occurring in a specified fluid supply device, which cause a need to reduce the power output considering economic efficiency and safety.

The term “second degradation” recited in claims and description refers to degradation occurring in the specified fluid supply device, which causes a need to stop the operation because the required operation state cannot be maintained because of economic efficiency and safety.

Numerous modifications and alternative embodiments of the invention will be apparent to those skilled in the art in the light of the foregoing description. Accordingly, the description is to be construed as illustrative only, and is provided for the purpose of teaching those skilled in the art the best mode of carrying out the invention. The details of the structure and/or function may be varied substantially without departing from the spirit of the invention.

### INDUSTRIAL APPLICABILITY

The fuel cell power generation system of the present invention is useful as a fuel cell power generation system that is able to continue the operation while inhibiting flow rate deficiency when degradation has occurred in the fluid supply device and to stop the operation when a predetermined condition is met.

1. A fuel cell power generation system comprising:
a fuel cell;
an object subjected to degradation determination which is at least one of one or more fluid supply devices that supply fluids associated with power generation in said fuel cell;
a flow rate detecting means that detects a flow rate of the fluid supplied from said object subjected to degradation determination;
a flow rate control means that controls the flow rate of the fluid supplied from said object subjected to degradation determination; and
an operation control means that controls an operation of said fuel cell power generation system; wherein
said operation control means reduces a power output of said fuel cell when the flow rate of the fluid that is supplied from said object subjected to degradation determination in response to a specified output command value given by said flow rate control means to said object subjected to degradation determination falls within a first degradation range, and stops the operation of said fuel cell power generation system when the flow rate falls within a second degradation range; and wherein
said object subjected to degradation determination is at least one of an oxidizing agent supply device that supplies an oxidizing gas to said fuel cell and a fuel supply device that supplies a fuel to said fuel cell.

2. The fuel cell power generation system according to claim 1, wherein
the specified output command value is an output command value actually given by said flow rate control means, and the flow rate of the fluid supplied from said object subjected to degradation determination is a detection value of the fluid that is detected by said flow rate detecting means when the output command value is given to said object subjected to degradation determination.

3. The fuel cell power generation system according to claim 1, wherein
the flow rate of the fluid supplied from said object subjected to degradation determination in response to the specified output command value given is a prediction value that is predicted based on the output command value actually given by said flow rate control means and the detection value of the flow rate that is detected by said flow rate detecting means when the output command value is actually given.

4. The fuel cell power generation system according to claim 3, wherein
the specified output command value is an output command value corresponding to a maximum power output.

5. The fuel cell power generation system according to claim 1, wherein
said flow rate detecting means includes a pressure detecting means that detects a pressure of the fluid supplied from said object subjected to degradation determination, and calculates the flow rate of the fluid based on the detected pressure.

6. (canceled)

7. (canceled)

8. The fuel cell power generation system according to claim 1, wherein
said operation control means executes a limited operation so that the power output of said fuel cell becomes not more than an upper limit value of the power output of said fuel cell corresponding to the flow rate for determination, when it is determined that the flow rate for determination falls within the first degradation range.

9. The fuel cell power generation system according to claim 8, wherein
the first degradation range is a range which causes economic advantage if the limited operation is continued, and the second degradation range is a range which causes economic disadvantage if the limited operation is continued.

10. The fuel cell power generation system according to claim 9, wherein
the second degradation range is a range in which the upper limit value of the power output of said fuel cell corresponding to the flow rate for determination is less than a predetermined power output.

11. The fuel cell power generation system according to claim 9, wherein
the second degradation range is a range in which efficiency of said fuel cell is less than a predetermined efficiency.

12. The fuel cell power generation system according to claim 9, further comprising:
a storage means that stores a rate structure of electric power and/or material; and
a cost calculating means that calculates supply cost of at least one of the electric power and heat supplied from said fuel cell power generation system and supply cost of at least one of electric power and heat supplied from an alternative means based on a predetermined rate structure of the electric power and the material; wherein
said second degradation range is a range in which the supply cost of the alternative means is less than the supply cost of said fuel cell power generation system.

13. The fuel cell power generation system according to claim 12, further comprising:
a communication means that obtains a current rate structure of the electric power and/or the material through communication; wherein
the rate structure stored in said storage means is updated to the rate structure obtained by said communication means.

14. The fuel cell power generation system according to claim 1, further comprising:
an operation time integrating means that integrates an operation time of said fuel cell power generation system;
a display means that displays information of said fuel cell power generation system; and
a time predicting means that predicts a time period that elapses until a detection value that is detected by said flow rate detecting means reaches the first degradation range and/or the second degradation range, based on the output command value given by said flow rate control means, the detection value detected by said flow rate detecting means, and the operation time integrated by said operation time integrating means; wherein
said display means displays the time period predicted by said time predicting means.

15. The fuel cell power generation system according to claim 1, further comprising:
a maintenance notification means which notifies that maintenance of said object subjected to degradation determination is needed when a detection value detected by said flow rate detecting means falls within the first degradation range.

16. The fuel cell power generation system according to claim 4, wherein
said operation control means executes a limited operation so that the power output of said fuel cell becomes not more than an upper limit value of the power output of said fuel cell corresponding to the flow rate for determination, when it is determined that the flow rate for determination falls within the first degradation range.

17. A fuel cell power generation system comprising:
a fuel processor that generates a fuel from water and a material;
a fuel cell;
an object subjected to degradation determination which is at least one of one or more fluid supply devices that supply fluids associated with power generation in said fuel cell;
a flow rate detecting means that detects a flow rate of the fluid supplied from said object subjected to degradation determination;
a flow rate control means that controls the flow rate of the fluid supplied from said object subjected to degradation determination; and
an operation control means that controls an operation of said fuel cell power generation system; wherein
said operation control means reduces a power output of said fuel cell when the flow rate of the fluid that is supplied from said object subjected to degradation determination in response to a specified output command value given by said flow rate control means to said object subjected to degradation determination falls within a first degradation range, and stops the operation of said fuel cell power generation system when the flow rate falls within a second degradation range; and wherein
said object subjected to degradation determination is at least one of a water supply device that supplies water to said fuel processor and a material supply device that supplies a material to said fuel processor.

18. The fuel cell power generation system according to claim 17, wherein
the specified output command value is an output command value actually given by said flow rate control means, and the flow rate of the fluid supplied from said object subjected to degradation determination is a detection value of the fluid that is detected by said flow rate detecting means when the output command value is given to said object subjected to degradation determination.

19. The fuel cell power generation system according to claim 17, wherein
the flow rate of the fluid supplied from said object subjected to degradation determination in response to the specified output command value given is a prediction value that is predicted based on the output command value actually given by said flow rate control means and the detection value of the flow rate that is detected by said flow rate detecting means when the output command value is actually given.

20. The fuel cell power generation system according to claim 19, wherein
the specified output command value is an output command value corresponding to a maximum power output.

21. The fuel cell power generation system according to claim 17, wherein
said flow rate detecting means includes a pressure detecting means that detects a pressure of the fluid supplied from said object subjected to degradation determination, and calculates the flow rate of the fluid based on the detected pressure.

22. The fuel cell power generation system according to claim 17, wherein
said operation control means executes a limited operation so that the power output of said fuel cell becomes not more than an upper limit value of the power output of said fuel cell corresponding to the flow rate for determination, when it is determined that the flow rate for determination falls within the first degradation range.

23. The fuel cell power generation system according to claim 22 wherein
the first degradation range is a range which causes economic advantage if the limited operation is continued, and the second degradation range is a range which causes economic disadvantage if the limited operation is continued.

24. The fuel cell power generation system according to claim 23, wherein
the second degradation range is a range in which the upper limit value of the power output of said fuel cell corresponding to the flow rate for determination is less than a predetermined power output.

25. The fuel cell power generation system according to claim 23, wherein
the second degradation range is a range in which efficiency of said fuel cell is less than a predetermined efficiency.

26. The fuel cell power generation system according to claim 23, further comprising:
a storage means that stores a rate structure of electric power and/or material; and
a cost calculating means that calculates supply cost of at least one of the electric power and heat supplied from said fuel cell power generation system and supply cost of at least one of electric power and heat supplied from an alternative means based on a predetermined rate structure of the electric power and the material; wherein
said second degradation range is a range in which the supply cost of the alternative means is less than the supply cost of said fuel cell power generation system.

27. The fuel cell power generation system according to claim 26, further comprising:
a communication means that obtains a current rate structure of the electric power and/or the material through communication; wherein
the rate structure stored in said storage means is updated to the rate structure obtained by said communication means.

28. The fuel cell power generation system according to claim 17, further comprising:
an operation time integrating means that integrates an operation time of said fuel cell power generation system;
a display means that displays information of said fuel cell power generation system; and
a time predicting means that predicts a time period that elapses until a detection value that is detected by said flow rate detecting means reaches the first degradation range and/or the second degradation range, based on the output command value given by said flow rate control means, the detection value detected by said flow rate detecting means, and the operation time integrated by said operation time integrating means; wherein
said display means displays the time period predicted by said time predicting means.

29. The fuel cell power generation system according to claim 17, further comprising:
a maintenance notification means which notifies that maintenance of said object subjected to degradation determination is needed when a detection value detected by said flow rate detecting means falls within the first degradation range.

30. The fuel cell power generation system according to claim 20, wherein
said operation control means executes a limited operation so that the power output of said fuel cell becomes not more than an upper limit value of the power output of said fuel cell corresponding to the flow rate for determination, when it is determined that the flow rate for determination falls within the first degradation range.
